(19) United States
(12) Patent Application Publication
(10) Pub. No.: US 2024/0114536 A1
(43) Pub. Date: Apr. 4, 2024

(54) RESOURCE SHARING FOR SIDELINK COMMUNICATION

(71) Applicant: QUALCOMM Incorporated, San Diego, CA (US)

(72) Inventors: Sourjya DUTTA, San Diego, CA (US); Gabi SARKIS, San Diego, CA (US); Tien Viet NGUYEN, Bridgewater, NJ (US); Qing LI, Princeton Junction, NJ (US)

(21) Appl. No.: 18/478,632

(22) Filed: Sep. 29, 2023

Related U.S. Application Data
(60) Provisional application No. 63/411,556, filed on Sep. 29, 2022.

(51) Int. Cl. H04W 72/40; H04W 72/12; H04W 72/56

(52) U.S. Cl. CPC H04W 72/40; H04W 72/12; H04W 72/56

(57) ABSTRACT

Aspects relate to dynamic resource sharing for sidelink communication. In some examples, a user equipment (UE) may modify a first sidelink transmission resource set associated with a first radio access technology (RAT) to exclude at least one resource indicated by a second sidelink transmission resource set associated with a second RAT. In some examples, a UE may prioritize certain transmissions. For example, a UE may drop a sidelink reception operation if there is a conflict with a sidelink transmission operation. In some examples, a UE may prioritize a particular RAT. For example, a UE may drop a sidelink transmission operation on a first RAT if there is a conflict with a sidelink transmission operation on a second RAT (e.g., the second RAT is deemed to have a higher priority).

### CROSS-REFERENCE TO RELATED APPLICATIONS

The present application for patent claims priority to and the benefit of pending U.S. Provisional Application No. 63/411,556, titled “RESOURCE SHARING FOR SIDELINK COMMUNICATION” filed Sep. 29, 2022, and assigned to the assignee hereof and hereby expressly incorporated by reference herein as if fully set forth below in its entirety and for all applicable purposes.

### TECHNICAL FIELD

The technology discussed below relates generally to wireless communication and, more particularly, to resource sharing for sidelink communication.

### INTRODUCTION

Wireless communication between devices may be facilitated by various network configurations. In one configuration, a cellular network may enable wireless communication devices to communicate with one another through signaling with a nearby base station or cell. Another wireless communication network configuration is a device to device (D2D) network, in which wireless communication devices may signal one another directly, rather than via an intermediary base station or cell. For example, D2D communication networks may utilize sidelink signaling to facilitate direct communication between wireless communication devices. In some sidelink network configurations, wireless communication devices may further communicate in a cellular network, generally under the control of a base station. Thus, the wireless communication devices may be configured for uplink and downlink signaling via a base station and further for sidelink signaling directly between the wireless communication devices without transmissions passing through the base station.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In some examples, a user equipment may include one or more memories storing processor-executable code, and one or more processors. The one or more processors may be configured to execute the processor-executable code to cause the user equipment to receive an indication of a first sidelink transmission resource set, the first sidelink transmission resource set being associated with at least one first sidelink communication for the user equipment via a first radio access technology (RAT) on a first radio frequency (RF) channel. The one or more processors may also be configured to execute the processor-executable code to cause the user equipment to communicate sidelink information for the user equipment on a second sidelink transmission resource set via a second RAT on the first RF channel, the second sidelink transmission resource set being based on a selective exclusion or inclusion of at least one resource indicated by the first sidelink transmission resource set.

In some examples, a method for wireless communication at a user equipment is disclosed. The method may include receiving an indication of a first sidelink transmission resource set, the first sidelink transmission resource set being associated with at least one first sidelink communication for the user equipment via a first radio access technology (RAT) on a first radio frequency (RF) channel. The method may also include communicating sidelink information for the user equipment on a second sidelink transmission resource set via a second RAT on the first RF channel, the second sidelink transmission resource set being based on selectively excluding or including at least one resource indicated by the first sidelink transmission resource set.

In some examples, a user equipment may include means for receiving an indication of a first sidelink transmission resource set, the first sidelink transmission resource set being associated with at least one first sidelink communication for the user equipment via a first radio access technology (RAT) on a first radio frequency (RF) channel. The user equipment may also include means for communicating sidelink information for the user equipment on a second sidelink transmission resource set via a second RAT on the first RF channel, the second sidelink transmission resource set being based on selectively excluding or including at least one resource indicated by the first sidelink transmission resource set.

In some examples, a non-transitory computer-readable medium has stored therein instructions executable by one or more processors of a user equipment to receive an indication of a first sidelink transmission resource set, the first sidelink transmission resource set being associated with at least one first sidelink communication for the user equipment via a first radio access technology (RAT) on a first radio frequency (RF) channel. The computer-readable medium may also have stored therein instructions executable by one or more processors of the user equipment to communicate sidelink information for the user equipment on a second sidelink transmission resource set via a second RAT on the first RF channel, the second sidelink transmission resource set being based on a selective exclusion or inclusion of at least one resource indicated by the first sidelink transmission resource set.

In some examples, a user equipment may include one or more memories storing processor-executable code, and one or more processors. The one or more processors may be configured to execute the processor-executable code to cause the user equipment to schedule a first sidelink communication for the user equipment via a first radio access technology (RAT) on a first radio frequency (RF) channel. The one or more processors may also be configured to execute the processor-executable code to cause the user equipment to receive an indication of a scheduled second sidelink communication for the user equipment, the second sidelink communication being via a second RAT on the first RF channel. The one or more processors may further be configured to execute the processor-executable code to cause the user equipment to selectively communicate the first sidelink communication or the second sidelink communication based on a prioritization and a conflict between the first sidelink communication and the second sidelink communication.

In some examples, a method for wireless communication at a user equipment is disclosed. The method may include scheduling a first sidelink communication for the user equipment via a first radio access technology (RAT) on a first radio frequency (RF) channel. The method may also include receiving an indication of a scheduled second sidelink communication for the user equipment, the second sidelink communication being via a second RAT on the first RF channel. The method may further include selectively communicating the first sidelink communication or the second sidelink communication based on a prioritization and a conflict between the first sidelink communication and the second sidelink communication.

In some examples, a user equipment may include means for scheduling a first sidelink communication for the user equipment via a first radio access technology (RAT) on a first radio frequency (RF) channel. The user equipment may also include means for receiving an indication of a scheduled second sidelink communication for the user equipment, the second sidelink communication being via a second RAT on the first RF channel. The user equipment may further include means for selectively communicating the first sidelink communication or the second sidelink communication based on a prioritization and a conflict between the first sidelink communication and the second sidelink communication.

In some examples, a non-transitory computer-readable medium has stored therein instructions executable by one or more processors of a user equipment to schedule a first sidelink communication for the user equipment via a first radio access technology (RAT) on a first radio frequency (RF) channel. The computer-readable medium may also have stored therein instructions executable by one or more processors of the user equipment to receive an indication of a scheduled second sidelink communication for the user equipment, the second sidelink communication being via a second RAT on the first RF channel. The computer-readable medium may further have stored therein instructions executable by one or more processors of the user equipment to selectively communicate the first sidelink communication or the second sidelink communication based on a prioritization and a conflict between the first sidelink communication and the second sidelink communication.

These and other aspects of the disclosure will become more fully understood upon a review of the detailed description, which follows. Other aspects, features, and examples of the present disclosure will become apparent to those of ordinary skill in the art, upon reviewing the following description of specific, example aspects of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In similar fashion, while example aspects may be discussed below as device, system, or method examples it should be understood that such example aspects can be implemented in various devices, systems, and methods.

### BRIEF DESCRIPTION OF THE DRAWINGS

FIG. 1 is a diagram illustrating an example of a wireless radio access network according to some aspects.

FIG. 2 is a schematic diagram illustrating organization of wireless resources in an air interface utilizing orthogonal frequency divisional multiplexing (OFDM) according to some aspects.

FIG. 3 is a conceptual illustration of an example of a wireless communication network employing sidelink communication according to some aspects.

FIG. 4A is a conceptual diagram illustrating an example of a sidelink slot structure according to some aspects.

FIG. 4B is a conceptual diagram illustrating another example of a sidelink slot structure according to some aspects.

FIG. 5 is a conceptual illustration of an example of a sidelink user equipment according to some aspects.

FIG. 6 is a diagram illustrating examples of sidelink transmission resource sets according to some aspects.

FIG. 7 is a signaling diagram illustrating an example of signaling associated with dynamic resource sharing involving an exclusion of resources from a sidelink transmission resource set according to some aspects.

FIG. 8 is a signaling diagram illustrating an example of signaling associated with dynamic resource sharing involving prioritized transmissions according to some aspects.

FIG. 9 is a signaling diagram illustrating an example of signaling associated with dynamic resource sharing involving prioritized radio access technologies (RATs) according to some aspects.

FIG. 10 is a block diagram illustrating an example of a hardware implementation for a user equipment employing a processing system according to some aspects.

FIG. 11 is a flow chart of an example method that involves dropping a scheduled communication according to some aspects.

FIG. 12 is a flow chart of an example method that involves retransmitting a dropped communication according to some aspects.

FIG. 13 is a flow chart of an example method that involves selectively excluding or including at least one resource according to some aspects.

FIG. 14 is a flow chart of an example method that involves selective communication based on a conflict and transmission prioritization according to some aspects.

FIG. 15 is a flow chart of an example method that involves selective communication based on a conflict and radio access technology (RAT) prioritization according to some aspects.

FIG. 16 is a flow chart of an example method that involves selective communication based on a conflict and a prioritization according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence-enabled (AI-enabled) devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

The disclosure relates in some aspects to dynamic resource sharing for sidelink communication. In some aspects, this dynamic resource sharing may be applicable to scenarios where long term evolution (LTE) sidelink communication and new radio (NR) sidelink communication use the same RF channel and are scheduled at overlapping times (e.g., scenarios where an NR sidelink user equipment (UE) and an LTE sidelink UE use a common resource pool). The disclosure relates in some aspects to operations of a dual RAT sidelink UE that support efficient dynamic resource sharing between NR sidelink and LTE sidelink UEs in a common resource pool. Dynamic resource sharing may be applicable to other scenarios as well.

In some examples, a first transmission resource set may be defined for LTE sidelink transmissions and a second transmission resource set may be defined for NR sidelink transmissions. The disclosure relates in some aspects to sharing information about these resource sets so than one or both of the transmission resource sets may be modified to avoid transmission conflicts between LTE sidelink and NR sidelink. For example, a user equipment (UE) may modify one transmission resource set to exclude at least one resource indicated by another transmission resource set.

In some examples, a UE may prioritize certain transmissions. For example, a UE may drop an LTE sidelink reception operation if there is a conflict with an NR sidelink transmission operation. As another example, a UE may drop an NR sidelink reception operation if there is a conflict with an LTE sidelink transmission operation.

In some examples, a UE may prioritize a particular radio access technology (RAT). For example, a UE may drop an LTE sidelink transmission operation if there is a conflict with an NR sidelink transmission operation. In some examples, this prioritization may be employed when the transmissions have the same priority. In some examples, this prioritization may be employed irrespective of the priorities of the transmissions.

In some examples, a UE may retransmit a scheduled transmission that was dropped. For example, the UE may retransmit a scheduled transmission irrespective of a feedback status (e.g., the receipt of a positive acknowledgement (ACK) or a negative acknowledgement (NAK)) associated with the scheduled transmission.

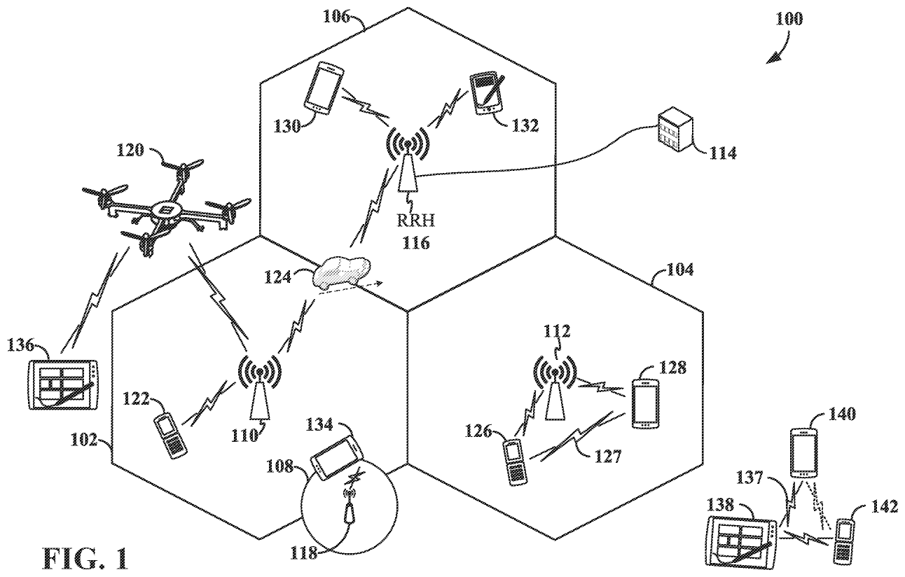

The various concepts presented throughout this disclosure may be implemented across a broad variety of telecommunication systems, network architectures, and communication standards. Referring now to FIG. 1, as an illustrative example without limitation, a schematic illustration of a radio access network (RAN) 100 is provided. The RAN 100 may implement any suitable wireless communication technology or technologies to provide radio access. As one example, the RAN 100 may operate according to 3^{rd} Generation Partnership Project (3GPP) New Radio (NR) specifications, often referred to as 5G. As another example, the RAN 100 may operate under a hybrid of 5G NR and Evolved Universal Terrestrial Radio Access Network (eUTRAN) standards, often referred to as Long Term Evolution (LTE). The 3GPP refers to this hybrid RAN as a next-generation RAN, or NG-RAN. Of course, many other examples may be utilized within the scope of the present disclosure.

The geographic region covered by the radio access network 100 may be divided into a number of cellular regions (cells) that can be uniquely identified by a user equipment (UE) based on an identification broadcasted over a geographical area from one access point or base station. FIG. 1 illustrates cells 102, 104, 106, and cell 108, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective base station (BS) serves each cell. Broadly, a base station is a network element in a radio access network responsible for radio transmission and reception in one or more cells to or from a UE. A BS may also be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 100 operates according to both the LTE and 5G NR standards, one of the base stations may be an LTE base station, while another base station may be a 5G NR base station.

Various base station arrangements can be utilized. For example, in FIG. 1, two base stations 110 and 112 are shown in cells 102 and 104; and a third base station 114 is shown controlling a remote radio head (RRH) 116 in cell 106. That is, a base station can have an integrated antenna or can be connected to an antenna or RRH by feeder cables. In the illustrated example, the cells 102, 104, and 106 may be referred to as macrocells, as the base stations 110, 112, and 114 support cells having a large size. Further, a base station 118 is shown in the cell 108 which may overlap with one or more macrocells. In this example, the cell 108 may be referred to as a small cell (e.g., a microcell, picocell, femtocell, home base station, home Node B, home eNode B, etc.), as the base station 118 supports a cell having a relatively small size. Cell sizing can be done according to system design as well as component constraints.

It is to be understood that the radio access network 100 may include any number of wireless base stations and cells. Further, a relay node may be deployed to extend the size or coverage area of a given cell. The base stations 110, 112, 114, 118 provide wireless access points to a core network for any number of mobile apparatuses.

FIG. 1 further includes an unmanned aerial vehicle (UAV) 120, which may be a drone or quadcopter. The UAV 120 may be configured to function as a base station, or more specifically as a mobile base station. That is, in some examples, a cell may not necessarily be stationary, and the geographic area of the cell may move according to the location of a mobile base station such as the UAV 120.

In general, base stations may include a backhaul interface for communication with a backhaul portion (not shown) of the network. The backhaul may provide a link between a base station and a core network (not shown), and in some examples, the backhaul may provide interconnection between the respective base stations. The core network may be a part of a wireless communication system and may be independent of the radio access technology used in the radio access network. Various types of backhaul interfaces may be employed, such as a direct physical connection, a virtual network, or the like using any suitable transport network.

The RAN 100 is illustrated supporting wireless communication for multiple mobile apparatuses. A mobile apparatus is commonly referred to as user equipment (UE) in standards and specifications promulgated by the 3rd Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Within the RAN 100, the cells may include UEs that may be in communication with one or more sectors of each cell. For example, UEs 122 and 124 may be in communication with base station 110; UEs 126 and 128 may be in communication with base station 112; UEs 130 and 132 may be in communication with base station 114 by way of RRH 116; UE 134 may be in communication with base station 118; and UE 136 may be in communication with mobile base station (e.g., the UAV 120). Here, each base station 110, 112, 114, 118, and the UAV 120 may be configured to provide an access point to a core network (not shown) for all the UEs in the respective cells. In some examples, the UAV 120 (e.g., the quadcopter) can be a mobile network node and may be configured to function as a UE. For example, the UAV 120 may operate within cell 102 by communicating with base station 110.

Wireless communication between a RAN 100 and a UE (e.g., UE 122 or 124) may be described as utilizing an air interface. Transmissions over the air interface from a base station (e.g., base station 110) to one or more UEs (e.g., UE 122 and 124) may be referred to as downlink (DL) transmission. In accordance with certain aspects of the present disclosure, the term downlink may refer to a point-to-multipoint transmission originating at a scheduling entity (described further below; e.g., base station 110). Another way to describe this scheme may be to use the term broadcast channel multiplexing. Transmissions from a UE (e.g., UE 122) to a base station (e.g., base station 110) may be referred to as uplink (UL) transmissions. In accordance with further aspects of the present disclosure, the term uplink may refer to a point-to-point transmission originating at a scheduled entity (described further below; e.g., UE 122).

For example, DL transmissions may include unicast or broadcast transmissions of control information and/or traffic information (e.g., user data traffic) from a base station (e.g., base station 110) to one or more UEs (e.g., UEs 122 and 124), while UL transmissions may include transmissions of control information and/or traffic information originating at a UE (e.g., UE 122). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 millisecond (ms). Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In some examples, access to the air interface may be scheduled, wherein a scheduling entity (e.g., a base station) allocates resources (e.g., time-frequency resources) for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs or scheduled entities utilize resources allocated by the scheduling entity.

Base stations are not the only entities that may function as a scheduling entity. That is, in some examples, a UE may function as a scheduling entity, scheduling resources for one or more scheduled entities (e.g., one or more other UEs). For example, two or more UEs (e.g., UEs 138, 140, and 142) may communicate with each other using sidelink signals 137 without relaying that communication through a base station. In some examples, the UEs 138, 140, and 142 may each function as a scheduling entity or transmitting sidelink device and/or a scheduled entity or a receiving sidelink device to schedule resources and communicate sidelink signals 137 therebetween without relying on scheduling or control information from a base station. In other examples, two or more UEs (e.g., UEs 126 and 128) within the coverage area of a base station (e.g., base station 112) may also communicate sidelink signals 127 over a direct link (sidelink) without conveying that communication through the base station 112. In this example, the base station 112 may allocate resources to the UEs 126 and 128 for the sidelink communication. In either case, such sidelink signaling 127 and 137 may be implemented in a peer-to-peer (P2P) network, a device-to-device (D2D) network, a vehicle-to-vehicle (V2V) network, a vehicle-to-everything (V2X) network, a mesh network, or other suitable direct link network.

In some examples, a D2D relay framework may be included within a cellular network to facilitate relaying of communication to/from the base station 112 via D2D links (e.g., sidelink signaling 127 or 137). For example, one or more UEs (e.g., UE 128) within the coverage area of the base station 112 may operate as relaying UEs to extend the coverage of the base station 112, improve the transmission reliability to one or more UEs (e.g., UE 126), and/or to allow the base station to recover from a failed UE link due to, for example, blockage or fading.

Two primary technologies that may be used by V2X networks include dedicated short range communication (DSRC) based on Institute of Electrical and Electronics Engineers (IEEE) 802.11p standards and cellular V2X based on LTE and/or 5G (New Radio) standards. Various aspects of the present disclosure may relate to New Radio (NR) cellular V2X networks, referred to herein as V2X networks, for simplicity. However, it should be understood that the concepts disclosed herein may not be limited to a particular V2X standard or may be directed to sidelink networks other than V2X networks.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of base stations and UEs may include suitable hardware and capabilities (e.g., an encoder, a decoder, and/or a CODEC) to utilize one or more of these channel codes for wireless communication.

In the RAN 100, the ability for a UE to communicate while moving, independent of their location, is referred to as mobility. The various physical channels between the UE and the RAN are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In some examples, a RAN 100 may enable mobility and handovers (i.e., the transfer of a UE's connection from one radio channel to another). For example, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 124 may move from the geographic area corresponding to its serving cell 102 to the geographic area corresponding to a neighbor cell 106. When the signal strength or quality from the neighbor cell 106 exceeds that of its serving cell 102 for a given amount of time, the UE 124 may transmit a reporting message to its serving base station 110 indicating this condition. In response, the UE 124 may receive a handover command, and the UE may undergo a handover to the cell 106.

In various implementations, the air interface in the RAN 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The air interface in the RAN 100 may utilize one or more multiplexing and multiple access algorithms to enable simultaneous communication of the various devices. For example, 5G NR specifications provide multiple access for UL or reverse link transmissions from UEs 122 and 124 to base station 110, and for multiplexing DL or forward link transmissions from the base station 110 to UEs 122 and 124 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 110 to UEs 122 and 124 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the air interface in the RAN 100 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

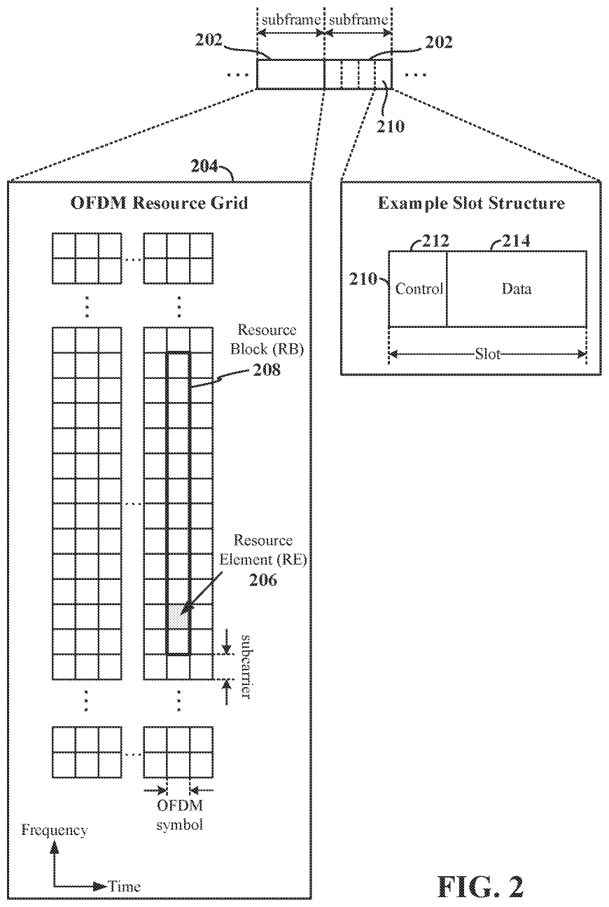

Various aspects of the present disclosure will be described with reference to an OFDM waveform, schematically illustrated in FIG. 2. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 2, an expanded view of an exemplary subframe 202 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 204 may be used to schematically represent time-frequency resources for a given antenna port. That is, in a multiple-input-multiple-output (MIMO) implementation with multiple antenna ports available, a corresponding multiple number of resource grids 204 may be available for communication. The resource grid 204 is divided into multiple resource elements (REs) 206. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 208, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 208 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of UEs or sidelink devices (hereinafter collectively referred to as UEs) for downlink, uplink, or sidelink transmissions typically involves scheduling one or more resource elements 206 within one or more sub-bands or bandwidth parts (BWPs). Thus, a UE generally utilizes only a subset of the resource grid 204. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a base station (e.g., gNB, eNB, etc.) or may be self-scheduled by a UE/sidelink device implementing D2D sidelink communication.

In this illustration, the RB 208 is shown as occupying less than the entire bandwidth of the subframe 202, with some subcarriers illustrated above and below the RB 208. In a given implementation, the subframe 202 may have a bandwidth corresponding to any number of one or more RBs 208. Further, in this illustration, the RB 208 is shown as occupying less than the entire duration of the subframe 202, although this is merely one possible example.

Each 1 ms subframe 202 may consist of one or multiple adjacent slots. In the example shown in FIG. 2, one subframe 202 includes four slots 210, as an illustrative example. In some examples, a slot may be defined according to a specified number of OFDM symbols with a given cyclic prefix (CP) length. For example, a slot may include 7 or 12 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 210 illustrates the slot 210 including a control region 212 and a data region 214. In general, the control region 212 may carry control channels, and the data region 214 may carry data channels. Of course, a slot may contain all DL, all UL, or at least one DL portion and at least one UL portion. The structure illustrated in FIG. 2 is merely exemplary in nature, and different slot structures may be utilized, and may include one or more of each of the control region(s) and data region(s).

Although not illustrated in FIG. 2, the various REs 206 within an RB 208 may be scheduled to carry one or more physical channels, including control channels, shared channels, data channels, etc. Other REs 206 within the RB 208 may also carry pilots or reference signals. These pilots or reference signals may provide for a receiving device to perform channel estimation of the corresponding channel, which may enable coherent demodulation/detection of the control and/or data channels within the RB 208.

In some examples, the slot 210 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 206 (e.g., within the control region 212) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NAK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NAK may be transmitted. In response to a NAK, the transmitting device may send a HARQ retransmission, which may implement chase combining, incremental redundancy, etc.

The base station may further allocate one or more REs 206 (e.g., in the control region 212 or the data region 214) to carry other DL signals, such as a demodulation reference signal (DMRS); a phase-tracking reference signal (PT-RS); a channel state information (CSI) reference signal (CSI-RS); and a synchronization signal block (SSB). SSB s may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESETO), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information.

In an UL transmission, the scheduled entity (e.g., UE) may utilize one or more REs 206 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 206 (e.g., within the data region 214) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 206 within the data region 214 may be configured to carry other signals, such as one or more SIB s and DMRSs.

In an example of sidelink communication over a sidelink carrier via a proximity service (ProSe) PC5 interface, the control region 212 of the slot 210 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 214 of the slot 210 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 206 within slot 210. For example, HARQ feedback information may be transmitted in a physical sidelink feedback channel (PSFCH) within the slot 210 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 210.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 2 are not necessarily all of the channels or carriers that may be utilized between devices, and those of ordinary skill in the art will recognize that other channels or carriers may be utilized in addition to those illustrated, such as other traffic, control, and feedback channels.

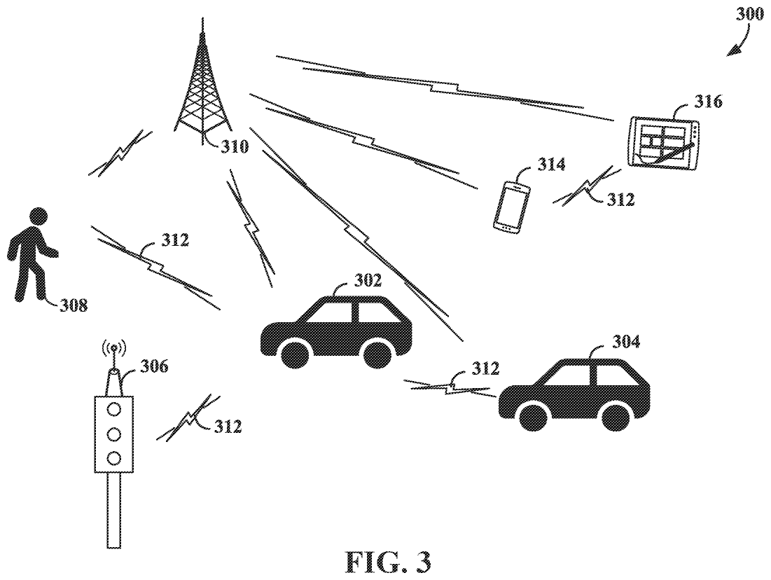

FIG. 3 illustrates an example of a wireless communication network 300 configured to support sidelink communication. In some examples, sidelink communication may include V2X communication. V2X communication involves the wireless exchange of information directly between not only vehicles (e.g., vehicles 302 and 304) themselves, but also directly between vehicles 302 and 304 and infrastructure (e.g., a roadside unit (RSU) 306), such as streetlights, buildings, traffic cameras, tollbooths or other stationary objects, between vehicles 302 and 304 and pedestrians 308 (e.g., including cyclists, etc.), and between vehicles 302 and 304 and wireless communication networks (e.g., network entity 310). In some examples, V2X communication may be implemented in accordance with the New Radio (NR) cellular V2X standard defined by 3GPP, Release 16, or other suitable standard.

V2X communication enables vehicles 302 and 304 to obtain information related to the weather, nearby accidents, road conditions, activities of nearby vehicles and pedestrians, objects nearby the vehicle, and other pertinent information that may be utilized to improve the vehicle driving experience and increase vehicle safety. In some examples, such V2X data may enable autonomous driving, improve road safety, and improve traffic efficiency. For example, the exchanged V2X data may be utilized by a V2X connected vehicle 302 and 304 to provide in-vehicle collision warnings, road hazard warnings, approaching emergency vehicle warnings, pre-/post-crash warnings and information, emergency brake warnings, traffic jam ahead warnings, lane change warnings, intelligent navigation services, and other similar information. In addition, V2X data received by a V2X connected mobile device of a pedestrian 308 may be utilized to trigger a warning sound, vibration, flashing light, etc., in case of imminent danger.

The sidelink communication between vehicle-UEs (V-UEs) (e.g., corresponding to the vehicles 302 and 304) or between a V-UE and either an RSU 306 or a pedestrian-UE (P-UE) (e.g., corresponding to the pedestrian 308) may occur over a sidelink 312 utilizing a proximity service (ProSe) PC5 interface. In various aspects of the disclosure, the PC5 interface may further be utilized to support D2D sidelink 312 communication in other proximity use cases. Examples of other proximity use cases may include public safety or commercial (e.g., entertainment, education, office, medical, and/or interactive) based proximity services. In the example shown in FIG. 3, ProSe communication may further occur between UEs 314 and 316.

ProSe communication may support different operational scenarios, such as in-coverage, out-of-coverage, and partial coverage. Out-of-coverage refers to a scenario in which UEs (e.g., V-UEs corresponding to the vehicles 302 and 304, and P-UEs corresponding to pedestrians 308) are outside of the coverage area of a network entity (e.g., network entity 310), but each are still configured for ProSe communication. Partial coverage refers to a scenario in which some of the UEs (e.g., a V-UE correspond to the vehicle 304) are outside of the coverage area of the network entity 310, while other UEs (e.g., a V-UE correspond to the vehicle 302, and P-UEs corresponding to pedestrians 308) are in communication with the network entity 310. In-coverage refers to a scenario in which UEs (e.g., UEs 314 and 316) are in communication with the network entity 310 (e.g., gNB) via a Uu (e.g., cellular interface) connection to receive ProSe service authorization and provisioning information to support ProSe operations.

To facilitate D2D sidelink communication between, for example, UEs 314 and 316 over the sidelink 312, the UEs 314 and 316 may transmit discovery signals therebetween. In some examples, each discovery signal may include a synchronization signal, such as a primary synchronization signal (PSS) and/or a secondary synchronization signal (SSS) that facilitates device discovery and enables synchronization of communication on the sidelink 312. For example, the discovery signal may be utilized by the UE 316 to measure the signal strength and channel status of a potential sidelink (e.g., sidelink 312) with another UE (e.g., UE 314). The UE 316 may utilize the measurement results to select a UE (e.g., UE 314) for sidelink communication or relay communication.

In 5G NR sidelink, sidelink communication may utilize transmission or reception resource pools. For example, the minimum resource allocation unit in frequency may be a sub-channel (e.g., which may include, for example, 10, 15, 20, 25, 50, 75, or 100 consecutive resource blocks) and the minimum resource allocation unit in time may be one slot. The number of sub-channels in a resource pool may include between one and twenty-seven sub-channels. A radio resource control (RRC) configuration of the resource pools may be either pre-configured (e.g., a factory setting on the UE determined, for example, by sidelink standards or specifications) or configured by a network entity (e.g., network entity 310).

In addition, there may be two main resource allocation modes of operation for sidelink (e.g., PC5) communications. In a first mode, Mode 1, a network entity (e.g., gNB) 310 may allocate resources to sidelink devices (e.g., V2X devices or other sidelink devices) for sidelink communication between the sidelink devices in various manners. For example, the network entity 310 may allocate sidelink resources dynamically (e.g., a dynamic grant) to sidelink devices, in response to requests for sidelink resources from the sidelink devices. For example, the network entity 310 may schedule the sidelink communication via DCI 2_0. In some examples, the network entity 310 may schedule the PSCCH/PSSCH within uplink resources indicated in DCI 2_0. The network entity 310 may further activate preconfigured sidelink grants (e.g., configured grants) for sidelink communication among the sidelink devices. In some examples, the network entity 310 may activate a configured grant (CG) via RRC signaling. In Mode 1, sidelink feedback may be reported back to the network entity 310 by a transmitting sidelink device.

In a second mode, Mode 2, the sidelink devices may autonomously select sidelink resources for sidelink communication therebetween. In some examples, a transmitting sidelink device may perform resource/channel sensing to select resources (e.g., sub-channels) on the sidelink channel that are unoccupied. Signaling on the sidelink is the same between the two modes. Therefore, from a receiver's point of view, there is no difference between the modes.

In some examples, sidelink (e.g., PC5) communication may be scheduled by use of sidelink control information (SCI). SCI may include two SCI stages. Stage 1 sidelink control information (first stage SCI) may be referred to herein as SCI-1. Stage 2 sidelink control information (second stage SCI) may be referred to herein as SCI-2.

SCI-1 may be transmitted on a physical sidelink control channel (PSCCH). SCI-1 may include information for resource allocation of a sidelink resource and for decoding of the second stage of sidelink control information (i.e., SCI-2). SCI-1 may further identify a priority level (e.g., Quality of Service (QoS)) of a PSSCH. For example, ultra-reliable-low-latency communication (URLLC) traffic may have a higher priority than text message traffic (e.g., short message service (SMS) traffic). SCI-1 may also include a physical sidelink shared channel (PSSCH) resource assignment and a resource reservation period (if enabled). Additionally, SCI-1 may include a PSSCH demodulation reference signal (DMRS) pattern (if more than one pattern is configured). The DMRS may be used by a receiver for radio channel estimation for demodulation of the associated physical channel. As indicated, SCI-1 may also include information about the SCI-2, for example, SCI-1 may disclose the format of the SCI-2. Here, the format indicates the resource size of SCI-2 (e.g., a number of REs that are allotted for SCI-2), a number of a PSSCH DMRS port(s), and a modulation and coding scheme (MCS) index. In some examples, SCI-1 may use two bits to indicate the SCI-2 format. Thus, in this example, four different SCI-2 formats may be supported. SCI-1 may include other information that is useful for establishing and decoding a PSSCH resource.

SCI-2 may be transmitted within the PSSCH and may contain information for decoding the PSSCH. According to some aspects, SCI-2 includes a 16-bit layer 1 (L1) destination identifier (ID), an 8-bit L1 source ID, a hybrid automatic repeat request (HARQ) process ID, a new data indicator (NDI), and a redundancy version (RV). For unicast communications, SCI-2 may further include a CSI report trigger. For groupcast communications, SCI-2 may further include a zone identifier and a maximum communication range for NAK. SCI-2 may include other information that is useful for establishing and decoding a PSSCH resource.

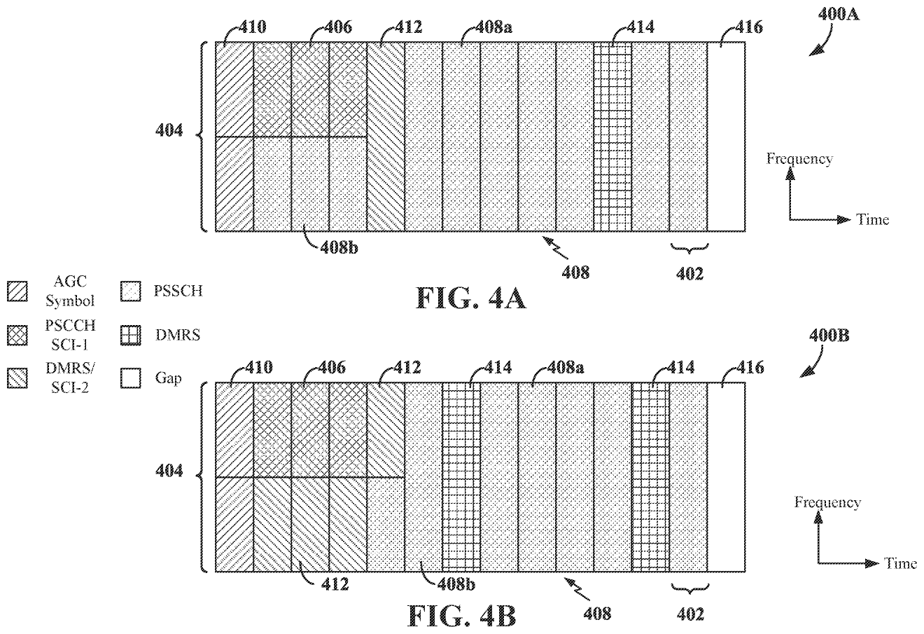

FIGS. 4A and 4B are diagrams illustrating examples of sidelink slot structures according to some aspects. The sidelink slot structures may be utilized, for example, in a V2X or other D2D network implementing sidelink. In the examples shown in FIGS. 4A and 4B, time is in the horizontal direction with units of symbols 402 (e.g., OFDM symbols); and frequency is in the vertical direction. Here, a carrier bandwidth 404 allocated for sidelink wireless communication is illustrated along the frequency axis. The carrier bandwidth 404 may include a plurality of sub-channels, where each sub-channel may include a configurable number of PRBs (e.g., 10, 14, 20, 24, 40, 44, or 100 PRBs).

Each of FIGS. 4A and 4B illustrate an example of a respective slot 400a or 400b including fourteen symbols 402 that may be used for sidelink communication. However, it should be understood that sidelink communication can be configured to occupy fewer than fourteen symbols in a slot 400a or 400b, and the disclosure is not limited to any particular number of symbols 402. Each sidelink slot 400a and 400b includes a physical sidelink control channel (PSCCH) 406 occupying a control region of the slot 400a and 400b. Each sidelink slot 400a and 400b includes a physical sidelink shared channel (PSSCH) 408 occupying a data region of each slot 400a and 400b. The PSCCH 406 and the PSSCH 408 are each transmitted on one or more symbols 402 of each slot 400a and 400b. The PSCCH 406 includes, for example, SCI-1 that schedules transmission of data traffic on time-frequency resources of the corresponding PSSCH 408. As shown in FIGS. 4A and 4B, the PSCCH 406 and corresponding PSSCH 408 are transmitted in the same slot 400a or 400b. In other examples, the PSCCH 406 may schedule a PSSCH (not shown) in a subsequent slot.

In some examples, the duration of the PSCCH 406 is configured to be two or three symbols. In addition, the PSCCH 406 may be configured to span a configurable number of PRBs, limited to a single sub-channel. For example, the PSCCH 406 may span 10, 12, 14, 20, or 24 PRBs of a single sub-channel. A DMRS may further be present in every PSCCH symbol. In some examples, the DMRS may be placed on every fourth RE of the PSCCH 406. A frequency domain orthogonal cover code (FD-OCC) may further be applied to the PSCCH DMRS to reduce the impact of colliding PSCCH transmissions on the sidelink channel. For example, a transmitting UE may randomly select the FD-OCC from a set of pre-defined FD-OCCs. In each of the examples shown in FIGS. 4A and 4B, the starting symbol for the PSCCH 406 is the second symbol of the corresponding slot 400a or 400b and the PSCCH 406 spans three symbols.

The PSSCH 408 may be time-division multiplexed (TDMed) with the PSCCH 406 and/or frequency-division multiplexed (FDMed) with the PSCCH 406. In the example shown in FIG. 4A, a first portion 408a of the PSSCH 408 is TDMed with the PSCCH 406 and a second portion 408b of the PSSCH 408 is FDMed with the PSCCH 406. In the example shown in FIG. 4B, the PSSCH 408 is TDMed with the PSCCH 406.

One and two layer transmissions of the PSSCH 408 may be supported with various modulation orders. For example, the PSSCH 408 may be modulated using quadrature phase-shift keying (QPSK), or quadrature amplitude modulation (QAM) such as 16-QAM, 64-QAM and 246-QAM.

The PSSCH 408 may include DMRSs 414 configured in a two, three, or four symbol DMRS pattern. In some examples, the slot 400a shown in FIG. 4A includes a two symbol DMRS pattern. In some examples, the slot 400b shown in FIG. 4B includes a three symbol DMRS pattern. In some examples, the transmitting UE can select the DMRS pattern and indicate the selected DMRS pattern in SCI-1, according to channel conditions. The DMRS pattern may be selected, for example, based on the number of PSSCH 408 symbols in the slot 400a or 400b. In addition, a gap symbol 416 is present after the PSSCH 408 in each slot 400a and 400b.

Each slot 400a and 400b further includes SCI-2 412 mapped to contiguous RBs in the PSSCH 408 starting from the first symbol containing a PSSCH DMRS. In the example shown in FIG. 4A, the first symbol containing a PSSCH DMRS is the fifth symbol occurring immediately after the last symbol carrying the PSCCH 406. Therefore, the SCI-2 (PSSCH DMRS) 412 is mapped to RBs within the fifth symbol. In the example shown in FIG. 4B, the first symbol containing a PSSCH DMRS is the second symbol, which also includes the PSCCH 406. In addition, the SCI-2 (PSSCH DMRS) 412 are shown spanning symbols two through five. Thus, in this example, the SCI-2 (PSSCH DMRS) 412 is FDMed with the PSCCH 406 in symbols two through four and TDMed with the PSCCH 406 in symbol five.

The SCI-2 may be scrambled separately from the sidelink shared channel. In addition, the SCI-2 may utilize QPSK. When the PSSCH transmission spans two layers, the SCI-2 modulation symbols may be copied on (e.g., repeated on) both layers. The SCI-1 in the PSCCH 406 may be blind decoded at the receiving wireless communication device. However, since the format, starting location, and number of REs of the SCI-2 may be derived from the SCI-1, blind decoding of SCI-2 is not needed at the receiver (receiving UE).

In each of FIGS. 4A and 4B, the second symbol of each slot 400a and 400b is copied onto (repeated on) a first symbol 410 thereof for automatic gain control (AGC) settling. For example, in FIG. 4A, the second symbol containing the PSCCH 406 FDMed with the second portion 408b of the PSSCH 408 may be transmitted on both the first symbol and the second symbol. In the example shown in FIG. 4B, the second symbol containing the PSCCH 406 FDMed with the SCI-2 (PSSCH DMRS) 412 may be transmitted on both the first symbol and the second symbol.

Sidelink communication may be used in different types of communication systems. For example, sidelink communication may be used in a communication system based on third generation partnership project (3GPP) long term evolution (LTE) technology (e.g., an LTE V2X system), in a communication system based on 3GPP new radio (NR) technology (e.g., an NR V2X system), or in a communication system based on some other technology.

In some examples, a user equipment (UE) may include an LTE sidelink module for communicating with other LTE sidelink devices and an NR sidelink module for communicating with other NR sidelink devices. For example, an NR V2X UE may be a dual radio device that can transmit basic safety message (BSM) packets, co-operative awareness message (CAM) packets, and other packets on LTE V2X and that can transmit sensor sharing and other traffic on NR V2X. In some examples, a UE that contains both LTE SL and NR SL modules may be referred to as a device Type A.

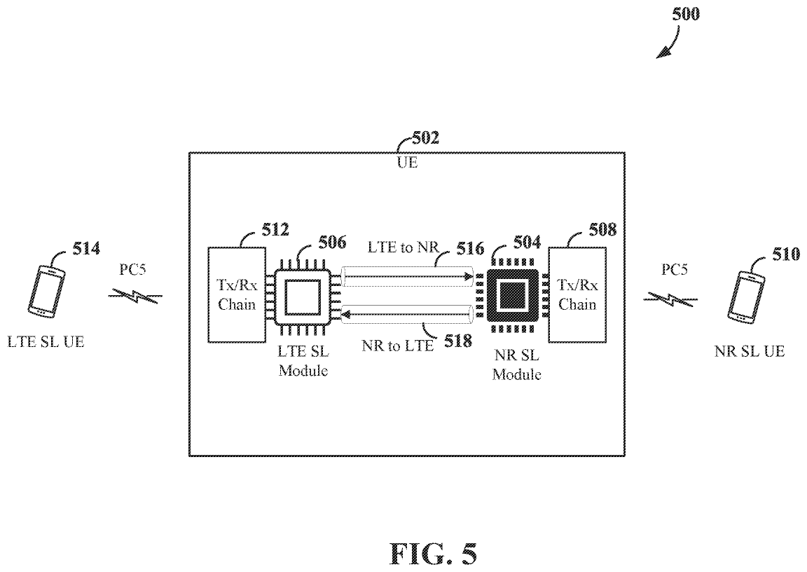

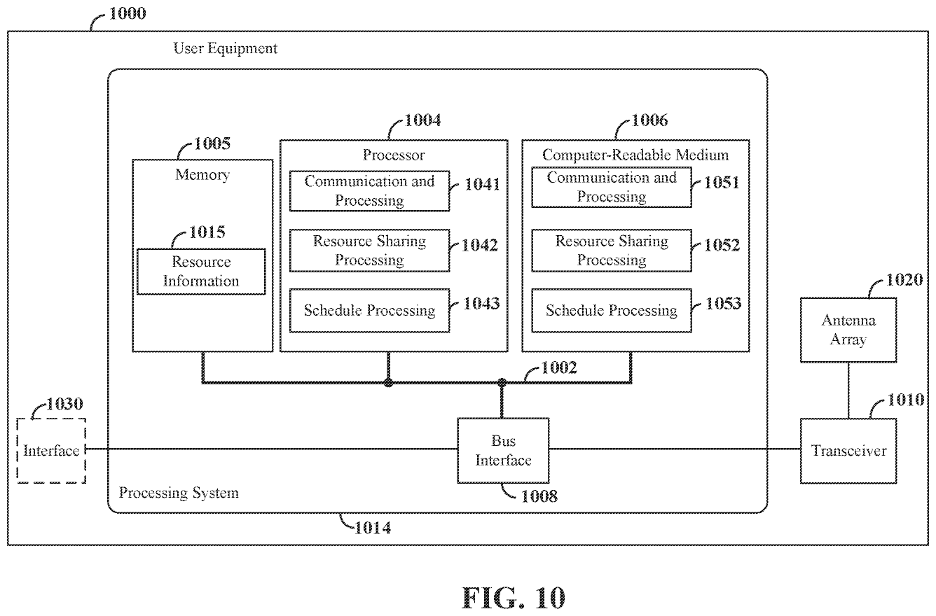

FIG. 5 illustrates an example of a wireless communication system 500 where a dual RAT UE 502 includes an NR sidelink module 504 and an LTE sidelink module 506. The NR sidelink module 504 can communicate via a transmit/receive (Tx/Rx) chain 508 with one or more NR sidelink UEs 510. The LTE sidelink module 506 can communicate via a transmit/receive (Tx/Rx) chain 512 with one or more LTE sidelink UEs 514. In this example, the dual RAT UE 502 includes a bi-directional interface that enables concurrent transmissions of signaling 516 from the LTE sidelink module 506 to the NR sidelink module 504 and signaling 518 from the NR sidelink module 504 to the LTE sidelink module 506. The NR sidelink module 504 may include one or more memories, one or more processors, and other circuitry (e.g., as described below in conjunction with FIG. 10). The LTE sidelink module 506 may include one or more memories, one or more processors, and other circuitry (e.g., as described below in conjunction with FIG. 10).

A defined set of wireless communication resources may be allocated for LTE sidelink communication and/or NR sidelink communication (e.g., to avoid or otherwise mitigate potential interference with non-sidelink communication). In some scenarios, LTE sidelink communication and NR sidelink communication may be allocated resources on the same radio frequency (RF) channel (e.g., a defined RF band or set of RF bands). For example, due to scarcity of spectrum, NR V2X and LTE V2X may have to operate in the same channel.

In scenarios where LTE sidelink communication and NR sidelink communication are allocated resources on the same RF channel, there is a possibility of interference between the LTE sidelink communication and NR sidelink communication (e.g., at a dual RAT UE). For example, in the absence of any coordination mechanism, an NR V2X transmission may collide with an LTE V2X transmission since these transmission may occupy the same time frequency resources. If such a collision occurs, the performance of both the NR V2X system and the LTE V2X may be degraded.

In some examples, a resource coordination mechanism may take the form of a resource pool partition. For example, the partition may specify that NR V2X can access a channel in some of the time slots defined by the partition and LTE V2X can access the channel in other time slots. However, both NR and LTE technologies and all of the UEs in the network would need to agree to the resource pool partition. Moreover, it would be desirable for the resource pool partition to evolve over time as the NR V2X penetration rate increases. In addition, it would be desirable for the resource pool to evolve based on changes in traffic over NR or LTE. Also, to mitigate any impact on legacy devices (e.g., LTE V2X UEs) that are already deployed, a resource coordination mechanism would preferably not impact legacy LTE procedures or modems.

In some examples, a resource coordination mechanism may be employed in a mode of operation where network connectivity (e.g., to a base station) is not available (e.g., an out-of-coverage scenario). For example, the combination of operational modes Mode 2 NR sidelink (SL) with Mode 4 LTE SL (Combination A) is one use case.

For a dual RAT UE, an NR SL module may use sensing and resource reservation information shared by an LTE SL module for resource coordination. For example, the NR SL module may use LTE reservation information to determine the set of available transmission (Tx) resources (e.g., to determine LTE channel occupancy).

In some examples, an NR SL module may start with an initial set of available transmission resources. The NR SL module may then aggregate LTE sidelink control information over a period of time T win and update the transmission resource set based on the updated LTE occupancy (e.g., if the LTE occupancy is lower than originally estimated, more of the resources of the transmission resource set can be used for NR). In some examples, the NR SL module UE may use a look-up table (LUT) or fixed algorithm to map LTE occupancy and/or NR availability to an available transmission resource set. Resources may be time division multiplexed (e.g., for PSFCH slots) or frequency division multiplexed.

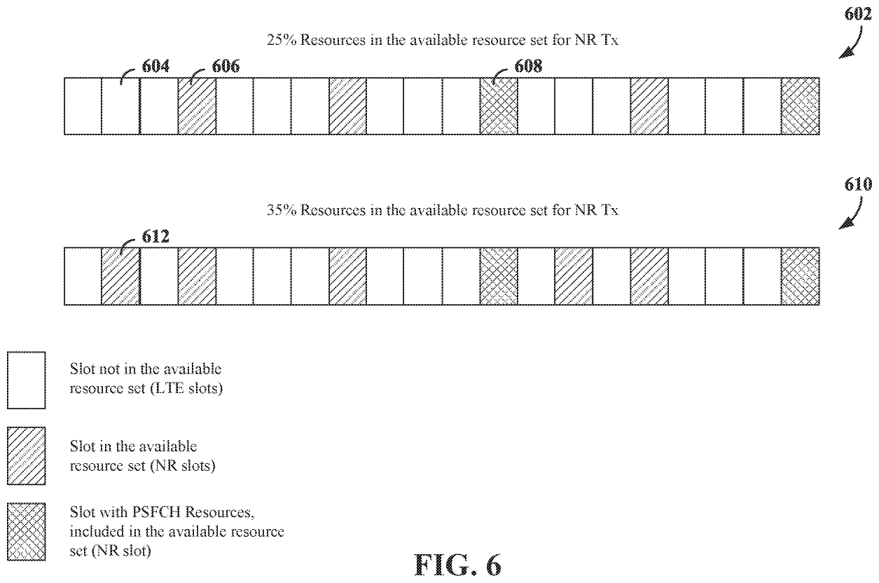

FIG. 6 illustrates two examples of NR sidelink transmission resource sets. A first NR sidelink transmission resource set 602 indicates that certain slots (e.g., slot 604) are not available for NR sidelink transmissions (e.g., these slots are allocated for LTE sidelink transmissions), that certain slots (e.g., slot 606) are available for NR sidelink transmissions, and that certain slots (e.g., slot 608) are available for the transmission of NR sidelink feedback. A second NR sidelink transmission resource set 610 indicates that additional slots (e.g., slot 612) are available for NR sidelink transmissions (e.g., these slots are not allocated for LTE sidelink transmissions in this case). Other NR sidelink transmission resource sets may be used in other examples.

In some examples, one or more sidelink transmission resource sets (e.g., for NR or LTE) may be preconfigured (e.g., upon deployment of a UE in a network) or predefined (e.g., by a wireless communication standard). In addition, the use of a particular one of these sidelink transmission resource sets may be specified for certain scenarios. For example, a UE may be configured to use the first NR sidelink transmission resource set 602 in scenarios where priority is given to LTE sidelink transmissions. In contrast, a UE may be configured to use the second NR sidelink transmission resource set 610 in scenarios where NR sidelink transmissions are given more priority.

In some examples, a UE may define the allocations of an NR sidelink transmission resource set. For example, the NR allocations may be defined based on LTE occupancy information received from an LTE sidelink module.

The disclosure relates in some aspects to dynamic resource sharing for sidelink communication. In some aspects, this dynamic resource sharing may be applicable to scenarios where LTE sidelink communication and NR sidelink communication use the same RF channel and are scheduled at overlapping times. Dynamic resource sharing may be applicable to other scenarios as well.

A first example (Example 1) involves LTE resource exclusion based on an NR transmission set indication. Here, based on LTE sensing results, an NR SL module may determine a NR transmission resource set and provide this to an LTE SL module. In this case, the LTE SL module may exclude the NR transmission resources from its set of transmission resources. To this end, the NR SL module may use a shared interface to notify the LTE SL module of a selected NR transmission set.

In some cases, upon receiving the NR transmission set, the LTE SL module may perform resource exclusion to avoid conflicts with NR. In one case, the LTE SL module can exclude all of the resources in the NR transmission set from its own set of transmission resources. In another case, the LTE SL module excludes only the slots where NR PSFCH resources are present from its own transmission resource set. In another case, the exclusion from the LTE resource set may be based on a relative priority between NR and LTE transmissions (e.g., if LTE has a higher priority, then NR resources may not be excluded from the LTE resource set).

In another case, upon receiving the NR transmission set, the LTE SL module may report the NR transmission set to the media access control (MAC) layer. The MAC layer may then select the resources from the candidate resource set, while not selecting resources that intersect with the NR transmission resource set.

A second example (Example 2) involves inter-RAT conflict resolution based on half-duplex constraints. In one scenario, a dual RAT UE prioritizes transmissions over receptions. For example, an LTE SL module may drop a reception if the reception conflicts with an NR transmission. As another example, an NR SL module may drop a reception if the reception conflicts with an LTE transmission. The NR SL module may transmit a NAK if an SCI had reserved the resource in the past, where the NAK resources are determined based on the reservation received in the earlier SCI.

In another scenario, a dual RAT UE prioritizes certain transmissions over other transmissions. For such a transmission-transmission conflict, a dual RAT UE may, based on a (pre)configuration, drop the transmission corresponding to either the first RAT (LTE) or the second RAT (NR). For example, a Type A UE may be (pre) configured to always drop LTE transmissions.

In one case, for slots with PSFCH resources or slots with PSFCH resources on which the collocated NR UE transmits or receives feedback, the LTE SL module may be configured to always drop transmissions.

In Example 2, the LTE SL module may exclude resources in a slot where its transmission or reception is dropped from its set of transmission resources. The LTE SL module may exclude the slot where the conflict happens and one or more future slots that are k×Tᵣₛᵥₚ slots away from the slot where the conflict is detected, where k=1, 2, . . . , k_max. The parameters k and Tᵣₛᵥₚ may be a part of the (pre)configuration.

A third example (Example 3) involves LTE resource exclusion based on inter-RAT prioritization. For example, a dual RAT UE may prioritize one RAT over another. In one case, a dual RAT UE performing dynamic resource sharing between NR and LTE is configured to prioritize NR SL transmissions/receptions over LTE SL transmissions/reception when the NR traffic and the LTE traffic have the same priorities. In another one case, a dual RAT UE performing dynamic resource sharing between NR and LTE is configured to prioritize NR SL transmissions/receptions over LTE SL transmissions/receptions irrespective of traffic priorities.

Resource exclusion may be employed in a scenario where a transmission or reception is dropped. For example, in Example 3, if the LTE SL module drops a transmission or reception due to an NR transmission/reception, the LTE SL module may exclude the slot where the conflict happens and one or more future slots that are k×Tᵣₛᵥₚ slots away from the slot where the conflict is detected, where k=1, 2, . . . , k_max. The parameters k and Tᵣₛᵥₚ may be a part of the (pre)configuration. In one case, if an LTE transmission/reception is dropped due to a conflict with an NR transmission/reception, the LTE SL module indicates to the NR SL module the resource/slot over which the transmission(s) were dropped along with periodic future reservations. In this case, the NR SL module may exclude the indicated resources from the determined NR transmission set (e.g., to prevent a conflict in the future).

A fourth example (Example 4) involves conducting a retransmission in the event a transmission (e.g., a packet) is dropped (e.g., for an NR SL module of a dual RAT UE that drops a transmission). In one case, when a transmission is dropped, the NR SL module retransmits the packet regardless of feedback status (e.g., receipt of a NAK is not required to trigger retransmission). In one case, the NR SL module retransmits the packet if the number of retransmissions does not exceed a (pre)configured maximum number of retransmissions. In another case, the NR SL module re-transmits the packet if the sum of the number of retransmissions and the number of dropped transmissions for the packet does not exceed a (pre)configured maximum.

When the NR SL module elects to retransmit a packet after a transmission is dropped, the NR SL module may select resources for the retransmission. In one case, the NR SL module may select a new set of resources for the future retransmissions of the packet. In another case, the NR SL module may use for future retransmissions the same set of resources that were scheduled for the dropped transmission. In another case, the NR SL module may use the resources that have already been reserved for the next retransmissions while selecting new resources for additional future retransmissions.

A fifth example (Example 5) involves a hardware implementation for bi-directional exchange. For example, the indication for transmission/reception dropping and/or a transmission resource set may be exchanged over a bi-directional interface between an NR SL module and an LTE SL module. Here, since some of the indications can be time sensitive, queuing them over a unidirectional link may induce undesirably large delays. By using a bi-directional interface instead, these delays can be reduced.

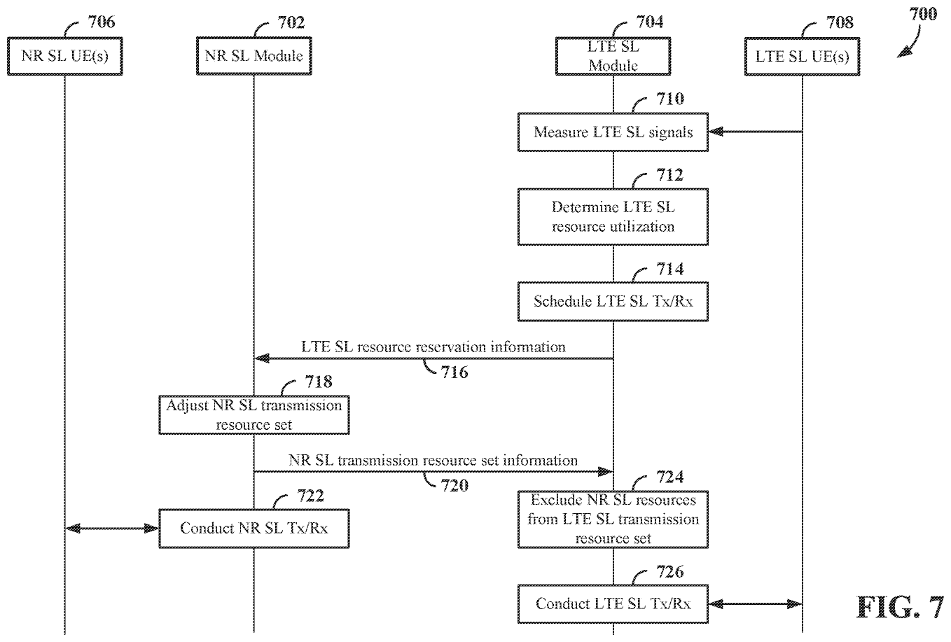

FIG. 7 is a signaling diagram 700 illustrating an example of signaling associated with sidelink communication in a wireless communication system including an NR sidelink module 702, an LTE sidelink module 704, at least one NR UE 706, and at least one LTE UE 708. In some examples, the NR sidelink module 702, the LTE sidelink module 704, the at least one NR UE 706, and the at least one LTE UE 708 may correspond to or be incorporated into any of the UEs or scheduled entities shown in any of FIGS. 1, 3, 5, 8, 9, and 10. In some examples, the NR sidelink module 702 and the LTE sidelink module 704 are co-located in the same UE (e.g., as depicted in FIG. 5).

At 710 of FIG. 7, the LTE sidelink module 704 measures LTE sidelink signals transmitted by the at least one LTE UE 708. For example, the LTE sidelink module 704 may measure the received signal strength indication (RSSI) of signals detected on at least one allocated LTE sidelink channel. As another example, the LTE sidelink module 704 may receive and decode sidelink control information (e.g., including scheduling information for one of more of the at least one LTE UE 708) that was transmitted on at least one allocated LTE sidelink channel.

At 712, the LTE sidelink module 704 determines (e.g., estimates) the resource utilization on the at least one allocated LTE sidelink channel measured at 710. For example, the LTE sidelink module 704 may determine that a particular slot on a particular band is being used by an LTE sidelink device if the RSSI measured during that slot is greater than or equal to a threshold. As another example, the LTE sidelink module 704 may determine that a particular slot on a particular band is being used by an LTE sidelink UE if decoded sidelink control information indicates that a transmission is scheduled on that slot.

At 714, the LTE sidelink module 704 may schedule at least one LTE sidelink transmission or reception with one of more of the at least one LTE UE 708 on at least one LTE sidelink channel. For example, the LTE sidelink module 704 or a sidelink peer UE may reserve one or more slots on one or more channels.

At 716, the LTE sidelink module 704 may send LTE sidelink resource reservation information to the NR sidelink module 702. For example, the LTE sidelink module 704 may send an indication of which slots and/or channels are estimated or otherwise determined to be occupied by LTE sidelink transmissions (e.g., according to the determination of 712 and the scheduling of 714). In some examples, the LTE sidelink module 704 may send to the NR sidelink module 702 an indication of an LTE sidelink transmission resource set used by the LTE sidelink module 704.

At 718, the NR sidelink module 702 may adjust its NR sidelink transmission resource set based on the LTE sidelink resource reservation information received at 716. For example, as discussed herein, the NR sidelink module 702 may use the LTE sidelink resource reservation information to determine which resources of the NR sidelink transmission resource set are not being used for LTE sidelink transmissions, and can thus be used for NR sidelink transmissions.

At 720, the NR sidelink module 702 may send NR sidelink transmission resource set information (e.g., based on the adjustment of 718) to the LTE sidelink module 704. For example, the NR sidelink module 702 may send a bitmap that indicates the slots that will be used by a UE for NR sidelink transmission and NR sidelink reception. At 722, the NR sidelink module 702 may conduct these NR sidelink transmissions and receptions with one or more of the NR UEs 706.

At 724, the LTE sidelink module 704 may exclude NR sidelink resources from the LTE sidelink transmission resource set used by the LTE sidelink module 704. For example, as discussed herein, the LTE sidelink module 704 may exclude from the LTE sidelink transmission resource set one or more of the NR sidelink resources indicated by the NR sidelink transmission resource set information. At 726, the LTE sidelink module 704 may conduct LTE sidelink transmissions and receptions with one or more of the LTE UEs 708 on the resources indicated by the LTE sidelink transmission resource set modified at 724.

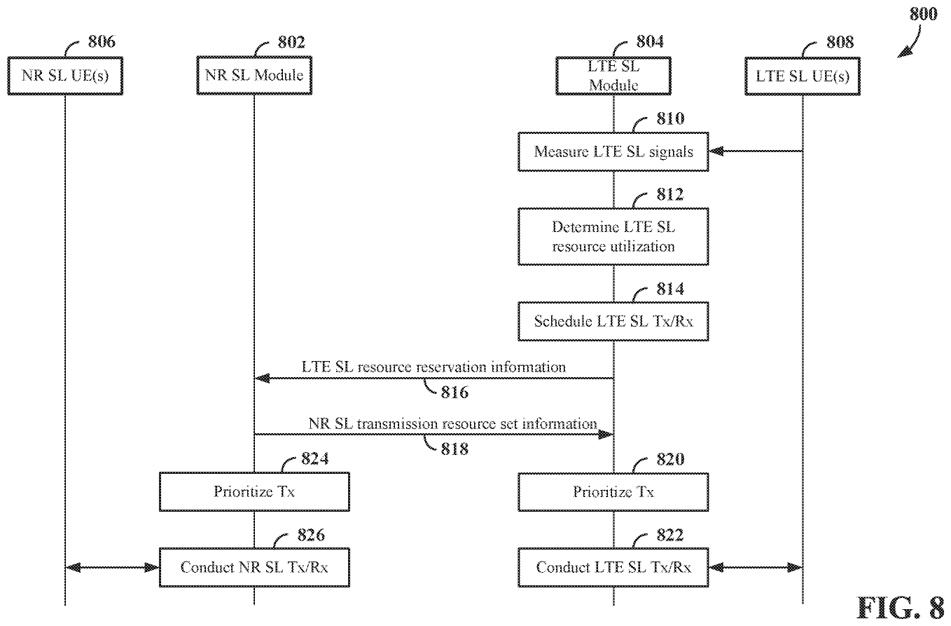

FIG. 8 is a signaling diagram 800 illustrating an example of signaling associated with sidelink communication in a wireless communication system including an NR sidelink module 802, an LTE sidelink module 804, at least one NR UE 806, and at least one LTE UE 808. In some examples, the NR sidelink module 802, the LTE sidelink module 804, the at least one NR UE 806, and the at least one LTE UE 808 may correspond to or be incorporated into any of the UEs or scheduled entities shown in any of FIGS. 1, 3, 5, 7, 9, and 10. In some examples, the NR sidelink module 802 and the LTE sidelink module 804 are co-located in the same UE (e.g., as depicted in FIG. 5).

At 810 of FIG. 8, the LTE sidelink module 804 measures LTE sidelink signals transmitted by the at least one LTE UE 808. For example, the LTE sidelink module 804 may measure the RSSI of signals detected on at least one allocated LTE sidelink channel. As another example, the LTE sidelink module 804 may receive and decode sidelink control information (e.g., including scheduling information for one of more of the at least one LTE UE 808) that was transmitted on at least one allocated LTE sidelink channel.

At 812, the LTE sidelink module 804 determines (e.g., estimates) the resource utilization on the at least one allocated LTE sidelink channel measured at 810. For example, the LTE sidelink module 804 may determine that a particular slot on a particular band is being used by an LTE sidelink device if the RSSI measured during that slot is greater than or equal to a threshold. As another example, the LTE sidelink module 804 may determine that a particular slot on a particular band is being used by an LTE sidelink UE if decoded sidelink control information indicates that a transmission is scheduled on that slot.

At 814, the LTE sidelink module 804 may schedule at least one LTE sidelink transmission or reception with one of more of the at least one LTE UE 808 on at least one LTE sidelink channel. For example, the LTE sidelink module 804 or a sidelink peer UE may reserve one or more slots on one or more channels.

At 816, the LTE sidelink module 804 may send LTE sidelink resource reservation information to the NR sidelink module 802. For example, the LTE sidelink module 804 may send an indication of which slots and/or channels are estimated or otherwise determined to be occupied by LTE sidelink transmissions (e.g., according to the determination of 812 and the scheduling of 814). In some examples, the LTE sidelink module 804 may send to the NR sidelink module 802 an indication of an LTE sidelink transmission resource set used by the LTE sidelink module 804.

At 818, the NR sidelink module 802 may send NR sidelink transmission resource set information (e.g., an NR sidelink transmission resource set adjusted based on the LTE sidelink resource reservation information received at 816) to the LTE sidelink module 804. For example, the NR sidelink module 802 may send a bitmap that indicates the slots that will be used by a UE for NR sidelink transmission and NR sidelink reception.

At 820, the LTE sidelink module 804 may prioritize certain transmissions. For example, as discussed herein, the LTE sidelink module 804 may prioritize transmissions over receptions, prioritize transmission on certain RATs, or prioritize feedback transmissions and receptions. At 822, the LTE sidelink module 804 may conduct LTE sidelink transmissions and receptions (e.g., transmissions with the highest priority) with one or more of the LTE UEs 808 on the resources indicated by the LTE sidelink transmission resource set.

At 824, the NR sidelink module 802 may prioritize certain transmissions. For example, as discussed herein, the NR sidelink module 802 may prioritize transmissions over receptions, prioritize transmission on certain RATs, or prioritize feedback transmissions. At 826, the NR sidelink module 802 may conduct these NR sidelink transmissions and receptions (e.g., transmissions with the highest priority) with one or more of the NR UEs 806.

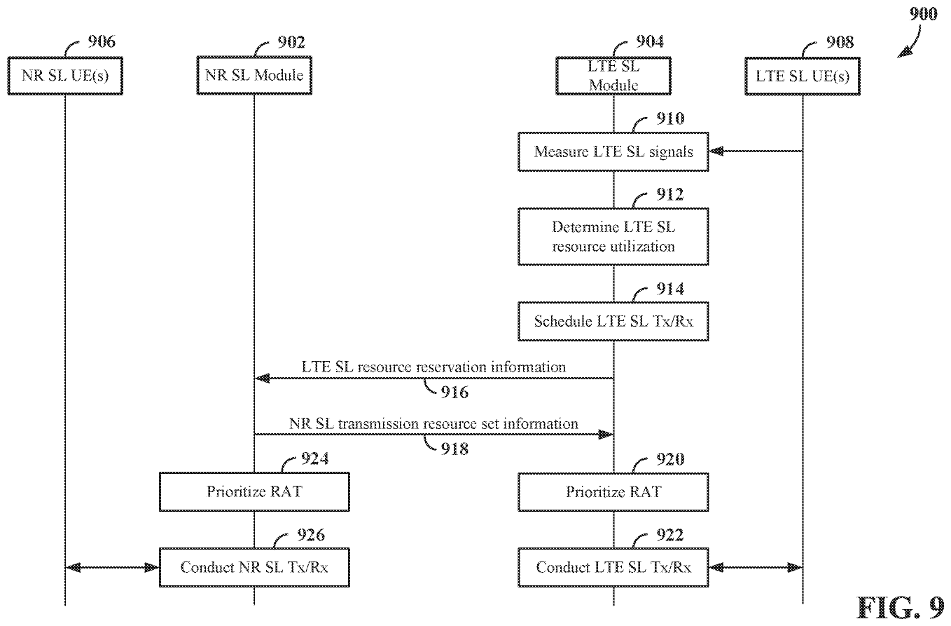

FIG. 9 is a signaling diagram 900 illustrating an example of signaling associated with sidelink communication in a wireless communication system including an NR sidelink module 902, an LTE sidelink module 904, at least one NR UE 906, and at least one LTE UE 908. In some examples, the NR sidelink module 902, the LTE sidelink module 904, the at least one NR UE 906, and the at least one LTE UE 908 may correspond to or be incorporated into any of the UEs or scheduled entities shown in any of FIGS. 1, 3, 5, 7, 8, and 10. In some examples, the NR sidelink module 902 and the LTE sidelink module 904 are co-located in the same UE (e.g., as depicted in FIG. 5).

At 910 of FIG. 9, the LTE sidelink module 904 measures LTE sidelink signals transmitted by the at least one LTE UE 908. For example, the LTE sidelink module 904 may measure the RSSI of signals detected on at least one allocated LTE sidelink channel. As another example, the LTE sidelink module 904 may receive and decode sidelink control information (e.g., including scheduling information for one of more of the at least one LTE UE 908) that was transmitted on at least one allocated LTE sidelink channel.

At 912, the LTE sidelink module 904 determines (e.g., estimates) the resource utilization on the at least one allocated LTE sidelink channel measured at 910. For example, the LTE sidelink module 904 may determine that a particular slot on a particular band is being used by an LTE sidelink device if the RSSI measured during that slot is greater than or equal to a threshold. As another example, the LTE sidelink module 904 may determine that a particular slot on a particular band is being used by an LTE sidelink UE if decoded sidelink control information indicates that a transmission is scheduled on that slot.

At 914, the LTE sidelink module 904 may schedule at least one LTE sidelink transmission or reception with one of more of the at least one LTE UE 908 on at least one LTE sidelink channel. For example, the LTE sidelink module 904 or a sidelink peer UE may reserve one or more slots on one or more channels.

At 916, the LTE sidelink module 904 may send LTE sidelink resource reservation information to the NR sidelink module 902. For example, the LTE sidelink module 904 may send an indication of which slots and/or channels are estimated or otherwise determined to be occupied by LTE sidelink transmissions (e.g., according to the determination of 912 and the scheduling of 914). In some examples, the LTE sidelink module 904 may send to the NR sidelink module 902 an indication of an LTE sidelink transmission resource set used by the LTE sidelink module 904.

At 918, the NR sidelink module 902 may send NR sidelink transmission resource set information (e.g., an NR sidelink transmission resource set adjusted based on the LTE sidelink resource reservation information received at 916) to the LTE sidelink module 904. For example, the NR sidelink module 902 may send a bitmap that indicates the slots that will be used by a UE for NR sidelink transmission and NR sidelink reception.

At 920, the LTE sidelink module 904 may prioritize the transmissions for a particular RAT. For example, as discussed herein, the LTE sidelink module 904 may prioritize NR sidelink transmissions over LTE sidelink transmissions. At 922, the LTE sidelink module 904 may conduct LTE sidelink transmissions and receptions (e.g., transmissions not dropped due to prioritization) with one or more of the LTE UEs 908 on the resources indicated by the LTE sidelink transmission resource set.

At 924, the NR sidelink module 902 may prioritize the transmissions for a particular RAT. For example, as discussed herein, the NR sidelink module 902 may prioritize NR sidelink transmissions over LTE sidelink transmissions. At 926, the NR sidelink module 902 may conduct these prioritize NR sidelink transmissions and receptions with one or more of the NR UEs 906.

FIG. 10 is a conceptual diagram illustrating an example of a hardware implementation for a user equipment (UE) 1000 employing a processing system 1014. In some examples, the user equipment 1000 may be a UE or scheduled entity configured to wirelessly communicate with a network entity or scheduling entity, as discussed in any one or more of FIGS. 1-9. In some examples, the user equipment 1000 may correspond to any of the UEs, sidelink devices, D2D devices, or scheduled entities shown in any of FIGS. 1, 3 5, 7, 8, and 9.

In accordance with various aspects of the disclosure, an element, or any portion of an element, or any combination of elements may be implemented with the processing system 1014. The processing system 1014 may include (e.g., comprises) one or more processors (referred to herein as the processor 1004, for convenience). Examples of processors 1004 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the user equipment 1000 may be configured to perform any one or more of the functions described herein. That is, the processor 1004, as utilized in a user equipment 1000, may be used to implement any one or more of the methods described herein.

The processor 1004 may in some instances be implemented via a baseband or modem chip and in other implementations, the processor 1004 may itself include a number of devices distinct and different from a baseband or modem chip (e.g., in such scenarios these devices may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1014 may be implemented with a bus architecture, represented generally by the bus 1002. The bus 1002 may include any number of interconnecting buses and bridges depending on the specific application of the processing system 1014 and the overall design constraints. The bus 1002 communicatively couples together various circuits including one or more processors (represented generally by the processor 1004), one or more memories (referred to herein as the memory 1005, for convenience), and one or more computer-readable media (represented generally by the computer-readable medium 1006). The bus 1002 may also link various other circuits such as timing sources, peripherals, voltage regulators, and power management circuits, which are well known in the art, and therefore, will not be described any further. A bus interface 1008 provides an interface between the bus 1002 and a transceiver 1010 and an antenna array 1020 and between the bus 1002 and an interface 1030. The transceiver 1010 provides a means for communicating with various other apparatus over a transmission medium (e.g., air interface). The interface 1030 provides a communication interface or means of communicating with various other apparatuses and devices (e.g., other devices housed within the same apparatus as the user equipment 1000 or other external apparatuses) over an internal bus or external transmission medium. Depending upon the nature of the user equipment 1000, the interface 1030 may include a user interface (e.g., keypad, display, speaker, microphone, joystick). Of course, such a user interface is optional, and may be omitted in some examples, such as an IoT device.

The processor 1004 is responsible for managing the bus 1002 and general processing, including the execution of software stored on the computer-readable medium 1006. The software, when executed by the processor 1004, causes the processing system 1014 to perform the various functions described below for any particular apparatus. The computer-readable medium 1006 and the memory 1005 may also be used for storing data that is manipulated by the processor 1004 when executing software. For example, the memory 1005 may store resource information 1015 used by the processor 1004 in cooperation with the transceiver 1010 for sidelink communication.

One or more processors 1004 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1006.

The computer-readable medium 1006 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 1006 may reside in the processing system 1014, external to the processing system 1014, or distributed across multiple entities including the processing system 1014. The computer-readable medium 1006 may be embodied in a computer program product. In some examples, the computer-readable medium 1006 may be part of the memory 1005. By way of example, a computer program product may include a computer-readable medium in packaging materials. Those skilled in the art will recognize how best to implement the described functionality presented throughout this disclosure depending on the particular application and the overall design constraints imposed on the overall system.

In some aspects of the disclosure, the processor 1004 may include circuitry configured for various functions. In some aspects, processor 1004 may include circuitry for performing one or more of the operations described herein with respect to FIGS. 1-9 and 11-16.

The processor 1004 may include communication and processing circuitry 1041, configured to communicate with a network entity and one or more other wireless communication devices. In some examples, the communication and processing circuitry 1041 may be configured to communicate over a common carrier shared between a cellular (e.g., Uu) interface and a sidelink (e.g., PC5) interface. In some examples, the communication and processing circuitry 1041 may include one or more hardware components that provide the physical structure that performs processes related to wireless communication (e.g., signal reception and/or signal transmission) and signal processing (e.g., processing a received signal and/or processing a signal for transmission). The communication and processing circuitry 1041 may further be configured to execute communication and processing software 1051 stored on the computer-readable medium 1006 to implement one or more functions described herein.

In some implementations where the communication involves receiving information, the communication and processing circuitry 1041 may obtain information from a component of the user equipment 1000 (e.g., from the transceiver 1010 that receives the information via radio frequency signaling or some other type of signaling suitable for the applicable communication medium), process (e.g., decode) the information, and output the processed information. For example, the communication and processing circuitry 1041 may output the information to another component of the processor 1004, to the memory 1005, or to the bus interface 1008. In some examples, the communication and processing circuitry 1041 may receive one or more of signals, messages, SCIs, feedback, other information, or any combination thereof. In some examples, the communication and processing circuitry 1041 may receive information via one or more of a PSCCH, a PSSCH, a PSFCH, some other type of channel, or any combination thereof. In some examples, the communication and processing circuitry 1041 may include functionality for a means for receiving (e.g., means for receiving a signal and/or means for receiving control information). In some examples, the communication and processing circuitry 1041 may include functionality for a means for decoding.

In some implementations where the communication involves sending (e.g., transmitting) information, the communication and processing circuitry 1041 may obtain information (e.g., from another component of the processor 1004, the memory 1005, or the bus interface 1008), process (e.g., encode) the information, and output the processed information. For example, the communication and processing circuitry 1041 may output the information to the transceiver 1010 (e.g., that transmits the information via radio frequency signaling or some other type of signaling suitable for the applicable communication medium). In some examples, the communication and processing circuitry 1041 may send one or more of signals, messages, SCIs, feedback, other information, or any combination thereof. In some examples, the communication and processing circuitry 1041 may send information via one or more of a PSCCH, a PSSCH, a PSFCH, some other type of channel, or any combination thereof. In some examples, the communication and processing circuitry 1041 may include functionality for a means for sending (e.g., means for transmitting). In some examples, the communication and processing circuitry 1041 may include functionality for a means for encoding.

The processor 1004 may include resource sharing processing circuitry 1042 configured to perform resource sharing processing-related operations as discussed herein (e.g., one or more of the operations described in conjunction with FIGS. 5-9). The resource sharing processing circuitry 1042 may be configured to execute resource sharing processing software 1052 included on the computer-readable medium 1006 to implement one or more functions described herein.

The resource sharing processing circuitry 1042 may include functionality for a means for receiving. In some examples, the resource sharing processing circuitry 1042 may be configured to receive an indication of an SL transmission resource set (e.g., as described above at 716 and 720 of FIG. 7). In some examples, the resource sharing processing circuitry 1042 may be configured to receive resource utilization information (e.g., by monitoring for LTE SL signaling).

The resource sharing processing circuitry 1042 may include functionality for a means for transmitting. In some examples, the resource sharing processing circuitry 1042 may be configured to transmit a NAK for a sidelink communication. In some examples, the resource sharing processing circuitry 1042 may be configured to transmit an indication of at least one resource associated a sidelink communication (e.g., as described above at 716 and 720 of FIG. 7).

The resource sharing processing circuitry 1042 may include functionality for a means for communicating (e.g., transmitting and/or receiving). In some examples, the resource sharing processing circuitry 1042 may be configured to communicate sidelink information for the UE on a sidelink transmission resource set via a particular RAT and on a particular channel (e.g., as described above at 722 and 726 of FIG. 7).

The resource sharing processing circuitry 1042 may include functionality for a means for selectively excluding or including at least one resource. In some examples, the resource sharing processing circuitry 1042 may be configured to modify a first sidelink transmission resource set to exclude or include some or all of the resources indicated by another sidelink transmission resource set (e.g., as described above at 718 and 724 of FIG. 7).

The resource sharing processing circuitry 1042 may include functionality for a means for selectively communicating. In some examples, the resource sharing processing circuitry 1042 may be configured to selectively communicating a first sidelink communication or a second sidelink communication based on a conflict between the first sidelink communication and the second sidelink communication and a prioritization associated with transmissions (e.g., as described above at 820-824 of FIG. 8). In some examples, the resource sharing processing circuitry 1042 may be configured to selectively communicating a first sidelink communication or a second sidelink communication based on a conflict between the first sidelink communication and the second sidelink communication and a RAT prioritization (e.g., as described above at 920-924 of FIG. 9).

The resource sharing processing circuitry 1042 may include functionality for a means for detecting a sidelink conflict. In some examples, the resource sharing processing circuitry 1042 may be configured to obtain sidelink schedule information and determine, based on the schedule information, whether a scheduled communication for an LTE sidelink module conflicts (e.g., in frequency and time) with a scheduled communication for an NR sidelink module.

The resource sharing processing circuitry 1042 may include functionality for a means for excluding at least one slot from a sidelink transmission resource set. For example, the schedule processing circuitry 1043 may be configured to generate a sidelink transmission resource set for a first sidelink communication that excludes certain slots (e.g., slots used for a second sidelink communication).

The processor 1004 may include schedule processing circuitry 1043 configured to perform schedule processing-related operations as discussed herein (e.g., one or more of the operations described in conjunction with FIGS. 5-9). The schedule processing circuitry 1043 may be configured to execute schedule processing software 1053 included on the computer-readable medium 1006 to implement one or more functions described herein.

The schedule processing circuitry 1043 may include functionality for a means for scheduling. For example, the schedule processing circuitry 1043 may be configured to schedule a sidelink communication for the UE on a sidelink transmission resource set via a particular RAT and on a particular channel.

The schedule processing circuitry 1043 may include functionality for a means for receiving. For example, the schedule processing circuitry 1043 may be configured to receive an indication of a scheduled second sidelink communication.

The schedule processing circuitry 1043 may include functionality for a means for transmitting. For example, the schedule processing circuitry 1043 may be configured to retransmit a sidelink communication.

The schedule processing circuitry 1043 may include functionality for a means for dropping (e.g., canceling) a sidelink communication (e.g., transmission and/or reception). For example, the schedule processing circuitry 1043 may be configured to cancel a previously scheduled transmission or reception for a first sidelink module due to a conflict with a previously scheduled transmission or reception for a second sidelink module.

The schedule processing circuitry 1043 may include functionality for a means for selecting resources for a sidelink retransmission. For example, the schedule processing circuitry 1043 may be configured to generate a sidelink transmission resource set for a retransmission that uses at least some of the resources that were previously scheduled for a dropped transmission. As another example, the schedule processing circuitry 1043 may be configured to generate a sidelink transmission resource set for a retransmission that uses resources other than the resources that were previously scheduled for a dropped transmission.

The schedule processing circuitry 1043 may include functionality for a means for retransmitting a sidelink retransmission independent of a feedback status of a transmission. For example, the schedule processing circuitry 1043 may be configured to initiate a retransmission responsive to a transmission being dropped (e.g., without waiting for feedback from a receiver). In some examples, the schedule processing circuitry 1043 may be configured to initiate a retransmission irrespective of feedback status as long as a maximum number of retransmissions and/or dropped transmissions is not exceeded.

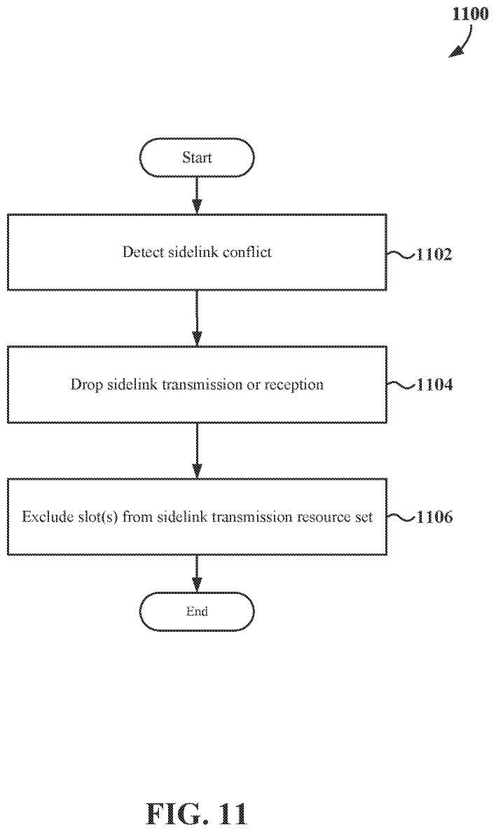

FIG. 11 is a flow chart of a method 1100 for wireless communication according to some aspects. As described below, some or all illustrated features may be omitted in a particular implementation within the scope of the present disclosure, and some illustrated features may not be required for implementation of all examples. In some examples, the method 1100 may be performed by the user equipment 1000 (e.g., performed by the processing system 1014), as described above and illustrated in FIG. 10, by a processor or processing system, or by any suitable means for carrying out the described functions.

At block 1102, a user equipment may detect a sidelink conflict. For example, the resource sharing processing circuitry 1042 together with the communication and processing circuitry 1041 and the transceiver 1010, shown and described above in connection with FIG. 10, may provide a means to detect a sidelink conflict.

In some examples, the user equipment may determine that an LTE sidelink communication (e.g., a transmission or reception) is scheduled on the same resources and at the same time as an NR sidelink communication (e.g., a transmission or reception).

At block 1104, the user equipment may drop a sidelink transmission or reception. For example, the schedule processing circuitry 1043 together with the communication and processing circuitry 1041 and the transceiver 1010, shown and described above in connection with FIG. 10, may provide a means to drop a sidelink transmission or reception.

In some examples, after detecting the sidelink conflict at block 1102, the user equipment may drop the LTE sidelink communication or the NR sidelink communication. The decision as to which transmission or reception to drop may be based on a transmission priority, a RAT priority, or some other criterion as discussed herein.

At block 1106, the user equipment may exclude one or more slots from a sidelink transmission resource set. For example, the resource sharing processing circuitry 1042 together with the communication and processing circuitry 1041 and the transceiver 1010, shown and described above in connection with FIG. 10, may provide a means to exclude one or more slots from a sidelink transmission resource set.

In some examples, after dropping the sidelink transmission or reception at block 1104, the user equipment may exclude resources in a slot where the sidelink transmission or reception is dropped and/or in one or more future slots.

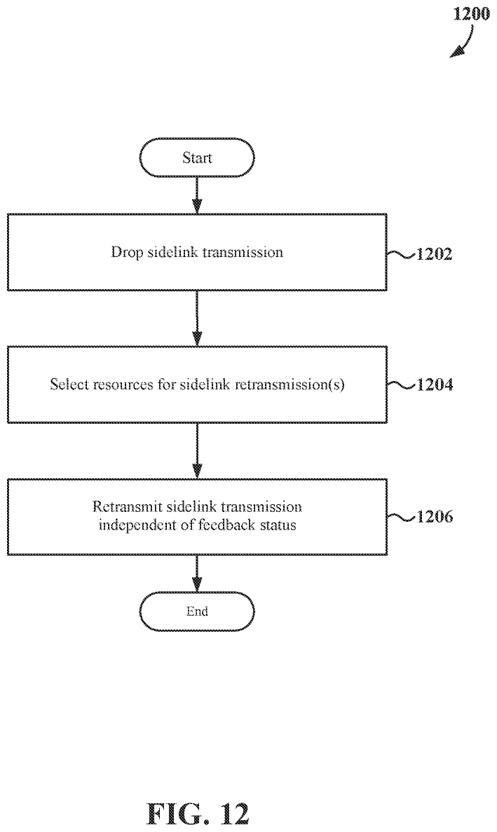

FIG. 12 is a flow chart of a method 1200 for wireless communication according to some aspects. As described below, some or all illustrated features may be omitted in a particular implementation within the scope of the present disclosure, and some illustrated features may not be required for implementation of all examples. In some examples, the method 1200 may be performed by the user equipment 1000 (e.g., performed by the processing system 1014), as described above and illustrated in FIG. 10, by a processor or processing system, or by any suitable means for carrying out the described functions.

At block 1202, a user equipment may drop a sidelink transmission. For example, the schedule processing circuitry 1043 together with the communication and processing circuitry 1041 and the transceiver 1010, shown and described above in connection with FIG. 10, may provide a means to drop a sidelink transmission.

In some examples, the user equipment may drop an LTE sidelink communication or an NR sidelink communication due to a conflict as discussed herein.

At block 1204, the user equipment may select resources for a sidelink retransmission. For example, the schedule processing circuitry 1043 together with the communication and processing circuitry 1041 and the transceiver 1010, shown and described above in connection with FIG. 10, may provide a means to select resources for a sidelink retransmission.

In some examples, after dropping the sidelink transmission at block 1202, the user equipment may select resources for transmitting the dropped transmission. As discussed herein, the user equipment may select the resources that were scheduled for the future retransmissions of the dropped transmission and/or the user equipment may select some other resources.

At block 1206, the user equipment may retransmit the sidelink transmission irrespective of feedback status. For example, the schedule processing circuitry 1043 together with the communication and processing circuitry 1041 and the transceiver 1010, shown and described above in connection with FIG. 10, may provide a means to retransmit the sidelink transmission irrespective of feedback status.

In some examples, after dropping the sidelink transmission at block 1202, the user equipment may transmit the data that was to be transmitted (e.g., on one or more of the resources selected at block 1204). As discussed herein, in contrast with some conventional retransmission schemes, the transmission at block 1206 may be conducted without considering feedback (e.g., receipt of a NAK is not a precondition to a retransmission).

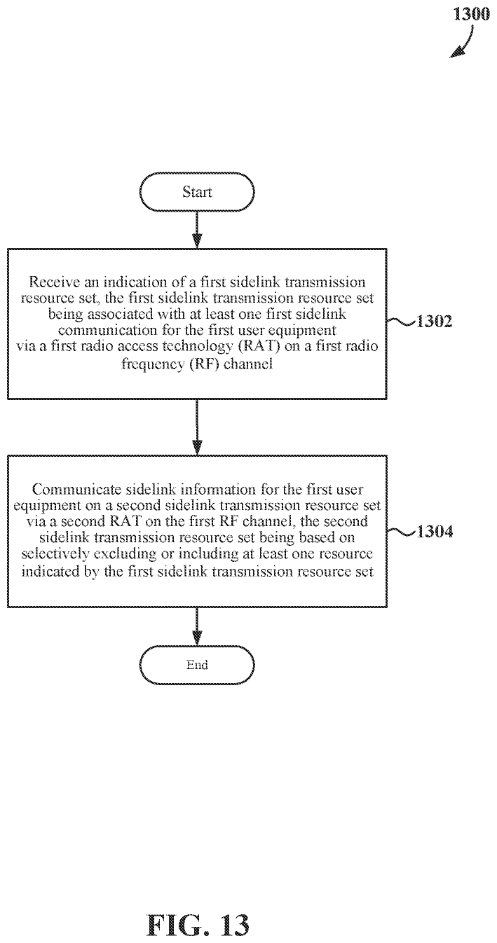

FIG. 13 is a flow chart of a method 1300 for wireless communication according to some aspects. As described below, some or all illustrated features may be omitted in a particular implementation within the scope of the present disclosure, and some illustrated features may not be required for implementation of all examples. In some examples, the method 1300 may be performed by the user equipment 1000 (e.g., performed by the processing system 1014), as described above and illustrated in FIG. 10, by a processor or processing system, or by any suitable means for carrying out the described functions.

At block 1302, a user equipment may receive an indication of a first sidelink transmission resource set, the first sidelink transmission resource set being associated with at least one first sidelink communication for the user equipment via a first RAT on a first radio frequency (RF) channel. For example, the resource sharing processing circuitry 1042 together with the communication and processing circuitry 1041 and the transceiver 1010, shown and described above in connection with FIG. 10, may provide a means to receive an indication of a first sidelink transmission resource set, the first sidelink transmission resource set being associated with at least one first sidelink communication for the user equipment via a first RAT on a first radio frequency (RF) channel.

At block 1304, a user equipment may communicate sidelink information for the user equipment on a second sidelink transmission resource set via a second RAT on the first RF channel, the second sidelink transmission resource set being based on selectively excluding or including at least one resource indicated by the first sidelink transmission resource set. For example, the schedule processing circuitry 1043 together with the communication and processing circuitry 1041 and the transceiver 1010, shown and described above in connection with FIG. 10, may provide a means to communicate sidelink information for the user equipment on a second sidelink transmission resource set via a second RAT on the first RF channel, the second sidelink transmission resource set being based on selectively excluding or including at least one resource indicated by the first sidelink transmission resource set.

In some examples, the second RAT may include a third generation partnership project (3GPP) long term evolution (LTE) technology. In some examples, the first RAT may include a 3GPP new radio (NR) technology. In some examples, the user equipment may include an LTE sidelink module and an NR sidelink module. In some examples, receiving the indication of the first sidelink transmission resource set may include receiving, at the LTE sidelink module, an NR transmission resource set from the NR sidelink module.

In some examples, the user equipment may receive first resource utilization information (e.g., the method include receiving first resource utilization information), the first resource utilization information being associated with at least one second sidelink communication via the second RAT on the first RF channel. In some examples, the second sidelink transmission resource set is based on the first resource utilization information.

In some examples, selectively excluding or including the at least one resource indicated by the first sidelink transmission resource set may include excluding all resources indicated by the first sidelink transmission resource set from the second sidelink transmission resource set. In some examples, selectively excluding or including the at least one resource indicated by the first sidelink transmission resource set may include excluding, from the second sidelink transmission resource set, slots with resources for feedback transmissions indicated by the first sidelink transmission resource set. In some examples, selectively excluding or including the at least one resource indicated by the first sidelink transmission resource set is based on a relative priority between transmissions via the first RAT and transmissions via the second RAT. In some examples, selectively excluding or including the at least one resource indicated by the first sidelink transmission resource set may include excluding, from the second sidelink transmission resource set, the at least one resource indicated by the first sidelink transmission resource set based on the first RAT being associated with a first priority that is higher than a second priority associated with the second RAT. In some examples, selectively excluding or including the at least one resource indicated by the first sidelink transmission resource set may include including, in the second sidelink transmission resource set, the at least one resource indicated by the first sidelink transmission resource set based on the first RAT being associated with a first priority that is lower than a second priority associated with the second RAT.

In some examples, the user equipment may include a third generation partnership project (3GPP) long term evolution (LTE) sidelink module and a 3GPP new radio (NR) sidelink module. In some examples, the LTE sidelink module forwards the indication of the first sidelink transmission resource set to a medium access control layer. In some examples, the medium access control layer updates the second sidelink transmission resource set based on the first sidelink transmission resource set.

In some examples, the user equipment may include a third generation partnership project (3GPP) long term evolution (LTE) sidelink module, a 3GPP new radio (NR) sidelink module, and a bi-directional interface between the LTE sidelink module and the NR sidelink module.

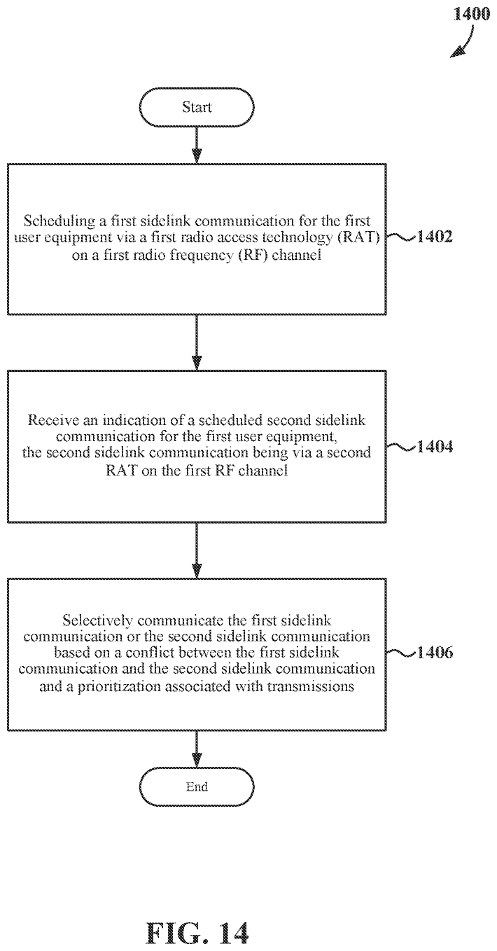

FIG. 14 is a flow chart of a method 1400 for wireless communication according to some aspects. As described below, some or all illustrated features may be omitted in a particular implementation within the scope of the present disclosure, and some illustrated features may not be required for implementation of all examples. In some examples, the method 1400 may be performed by the user equipment 1000 (e.g., performed by the processing system 1014), as described above and illustrated in FIG. 10, by a processor or processing system, or by any suitable means for carrying out the described functions.

At block 1402, a user equipment may schedule a first sidelink communication for the user equipment via a first radio access technology (RAT) on a first radio frequency (RF) channel. For example, the schedule processing circuitry 1043 together with the communication and processing circuitry 1041 and the transceiver 1010, shown and described above in connection with FIG. 10, may provide a means to schedule a first sidelink communication for the user equipment via a first radio access technology (RAT) on a first radio frequency (RF) channel.

At block 1404, a user equipment may receive an indication of a scheduled second sidelink communication for the user equipment, the second sidelink communication being via a second RAT on the first RF channel. For example, the schedule processing circuitry 1043 together with the communication and processing circuitry 1041 and the transceiver 1010, shown and described above in connection with FIG. 10, may provide a means to receive an indication of a scheduled second sidelink communication for the user equipment, the second sidelink communication being via a second RAT on the first RF channel.

At block 1406, a user equipment may selectively communicate the first sidelink communication or the second sidelink communication based on a conflict between the first sidelink communication and the second sidelink communication and a prioritization associated with transmissions. For example, the resource sharing processing circuitry 1042 together with the communication and processing circuitry 1041 and the transceiver 1010, shown and described above in connection with FIG. 10, may provide a means to selectively communicate the first sidelink communication or the second sidelink communication based on a conflict between the first sidelink communication and the second sidelink communication and a prioritization associated with transmissions.

In some examples, the first RAT may include a third generation partnership project (3GPP) long term evolution (LTE) technology. In some examples, the second RAT may include a 3GPP new radio (NR) technology.

In some examples, selectively communicating the first sidelink communication or the second sidelink communication based on the conflict between the first sidelink communication and the second sidelink communication and the prioritization associated with transmissions may include canceling the first sidelink communication based on the first sidelink communication being a receive operation and the second sidelink communication being a transmit operation.

In some examples, selectively communicating the first sidelink communication or the second sidelink communication based on the conflict between the first sidelink communication and the second sidelink communication and the prioritization associated with transmissions may include canceling the second sidelink communication based on the second sidelink communication being a receive operation and the first sidelink communication being a transmit operation.

In some examples, the user equipment may transmit a negative acknowledgement for the second sidelink communication based on a reservation of resources for the second sidelink communication, the negative acknowledgement being transmitted on a feedback resource indicated by sidelink control information that reserved the second sidelink communication.

In some examples, selectively communicating the first sidelink communication or the second sidelink communication based on the conflict between the first sidelink communication and the second sidelink communication and the prioritization associated with transmissions may include canceling the first sidelink communication based on a configuration that specifies that transmissions on the first RAT are to be dropped when there is a conflict between transmissions on the first RAT and the second RAT.

In some examples, selectively communicating the first sidelink communication or the second sidelink communication based on the conflict between the first sidelink transmission and the second sidelink transmission and the prioritization associated with transmissions may include canceling the second sidelink communication based on a configuration that specifies that transmissions on the second RAT are to be dropped when there is a conflict between transmissions on the first RAT and the second RAT.

In some examples, selectively communicating the first sidelink communication or the second sidelink communication based on the conflict between the first sidelink communication and the second sidelink communication and the prioritization associated with transmissions may include canceling the first sidelink communication. In some examples, the user equipment may selectively exclude at least one resource from a first sidelink transmission resource set associated with the first RAT based on the canceling the first sidelink communication. In some examples, the at least one resource may include at least one slot that is associated with a periodic resource allocation. In some examples, the at least one resource may include at least one slot that follows a first slot associated with the first sidelink communication by a quantity of slots specified by at least one configured parameter.

In some examples, selectively communicating the first sidelink communication or the second sidelink communication based on the conflict between the first sidelink communication and the second sidelink communication and the prioritization associated with transmissions may include canceling the second sidelink communication. In some examples, the user equipment may retransmit the second sidelink communication. In some examples, retransmitting the second sidelink communication is independent of a feedback status associated with the second sidelink communication. In some examples, retransmitting the second sidelink communication is based on whether a quantity of retransmissions for the second sidelink communication is greater than or equal to a threshold quantity of retransmissions associated with the second sidelink communication. In some examples, retransmitting the second sidelink communication is based on whether a quantity of retransmissions for the second sidelink communication is greater than or equal to a sum of a threshold quantity of retransmissions associated with the second sidelink communication and a quantity of dropped transmissions associated with the second sidelink communication.

In some examples, the user equipment may retransmit the second sidelink communication on a first set of resources that is different from a second set of resources scheduled for the second sidelink communication. In some examples, the user equipment may retransmit the second sidelink communication on the same set of resources that were scheduled for the second sidelink communication. In some examples, retransmitting the second sidelink communication may include transmitting at least a first retransmission of the second sidelink communication on a first set of resources that were scheduled for the second sidelink communication, and transmitting at least a second retransmission of the second sidelink communication on a second set of resources that is different from the first set of resources.

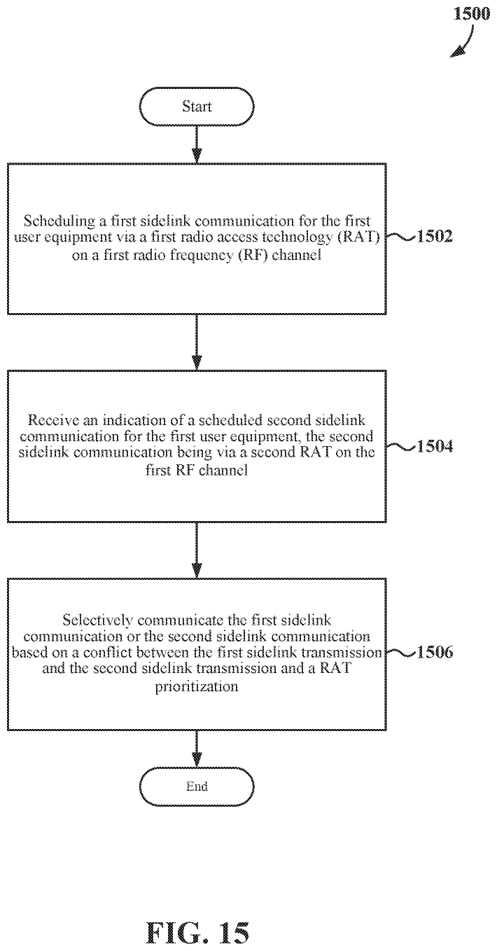

FIG. 15 is a flow chart of a method 1500 for wireless communication according to some aspects. As described below, some or all illustrated features may be omitted in a particular implementation within the scope of the present disclosure, and some illustrated features may not be required for implementation of all examples. In some examples, the method 1500 may be performed by the user equipment 1000 (e.g., performed by the processing system 1014), as described above and illustrated in FIG. 10, by a processor or processing system, or by any suitable means for carrying out the described functions.

At block 1502, a user equipment may schedule a first sidelink communication for the user equipment via a first radio access technology (RAT) on a first radio frequency (RF) channel. For example, the schedule processing circuitry 1043 together with the communication and processing circuitry 1041 and the transceiver 1010, shown and described above in connection with FIG. 10, may provide a means to schedule a first sidelink communication for the user equipment via a first radio access technology (RAT) on a first radio frequency (RF) channel.

At block 1504, a user equipment may receive an indication of a scheduled second sidelink communication for the user equipment, the second sidelink communication being via a second RAT on the first RF channel. For example, the schedule processing circuitry 1043 together with the communication and processing circuitry 1041 and the transceiver 1010, shown and described above in connection with FIG. 10, may provide a means to receive an indication of a scheduled second sidelink communication for the user equipment, the second sidelink communication being via a second RAT on the first RF channel.

At block 1506, a user equipment may selectively communicate the first sidelink communication or the second sidelink communication based on a conflict between the first sidelink transmission and the second sidelink transmission and a RAT prioritization. For example, the resource sharing processing circuitry 1042 together with the communication and processing circuitry 1041 and the transceiver 1010, shown and described above in connection with FIG. 10, may provide a means to selectively communicate the first sidelink communication or the second sidelink communication based on a conflict between the first sidelink transmission and the second sidelink transmission and a RAT prioritization.

In some examples, the first RAT may include a third generation partnership project (3GPP) long term evolution (LTE) technology. In some examples, the second RAT may include a 3GPP new radio (NR) technology.

In some examples, selectively communicating the first sidelink communication or the second sidelink communication based on the conflict between the first sidelink transmission and the second sidelink transmission and the RAT prioritization may include canceling the first sidelink communication based on a configuration that specifies that communications on the first RAT are to be dropped when there is a conflict between communications on the first RAT and the second RAT, and further based on the first sidelink communication and the second sidelink communication having the same priority.

In some examples, selectively communicating the first sidelink communication or the second sidelink communication based on the conflict between the first sidelink transmission and the second sidelink transmission and the RAT prioritization may include canceling the first sidelink communication based on a configuration that specifies that communications on the first RAT are to be dropped when there is a conflict between communications on the first RAT and the second RAT.

In some examples, selectively communicating the first sidelink communication or the second sidelink communication based on the conflict between the first sidelink transmission and the second sidelink transmission and the RAT prioritization may include canceling the first sidelink communication. In some examples, the user equipment may selectively exclude at least one resource from a first sidelink transmission resource set associated with the first RAT based on the canceling the first sidelink communication. In some examples, the at least one resource may include at least one slot that is associated with a periodic resource allocation. In some examples, the at least one resource may include at least one slot that follows a first slot associated with the first sidelink communication by a quantity of slots specified by at least one configured parameter.

In some examples, selectively communicating the first sidelink communication or the second sidelink communication based on the conflict between the first sidelink transmission and the second sidelink transmission and the RAT prioritization may include canceling the first sidelink communication. In some examples, the user equipment may transmit an indication of at least one resource associated with the first sidelink communication. In some examples, the at least one resource associated with the first sidelink communication may include a resource scheduled for a future sidelink communication via the first RAT.

In some examples, the user equipment may include a third generation partnership project (3GPP) long term evolution (LTE) sidelink module and a 3GPP new radio (NR) sidelink module. In some examples, transmitting the indication of the at least one resource may include the LTE sidelink module transmitting the indication to the NR sidelink module. In some examples, the NR sidelink module may exclude the at least one resource from a sidelink transmission resource set for the second RAT.

In some examples, selectively communicating the first sidelink communication or the second sidelink communication based on the conflict between the first sidelink transmission and the second sidelink transmission and the RAT prioritization may include canceling the second sidelink communication. In some examples, the user equipment may retransmit the second sidelink communication.

In some examples, retransmitting the second sidelink communication is independent of a feedback status associated with the second sidelink communication. In some examples, retransmitting the second sidelink communication is based on whether a quantity of retransmissions for the second sidelink communication is greater than or equal to a threshold quantity of retransmissions associated with the second sidelink communication. In some examples, retransmitting the second sidelink communication is based on whether a quantity of retransmissions for the second sidelink communication is greater than or equal to a sum of a threshold quantity of retransmissions associated with the second sidelink communication and a quantity of dropped transmissions associated with the second sidelink communication.

In some examples, the user equipment may retransmit the second sidelink communication on a first set of resources that is different from a second set of resources scheduled for the second sidelink communication. In some examples, the user equipment may retransmit the second sidelink communication on the same set of resources that were scheduled for the second sidelink communication. In some examples, retransmitting the second sidelink communication may include transmitting at least a first retransmission of the second sidelink communication on a first set of resources that were scheduled for the second sidelink communication, and transmitting at least a second retransmission of the second sidelink communication on a second set of resources that is different from the first set of resources.

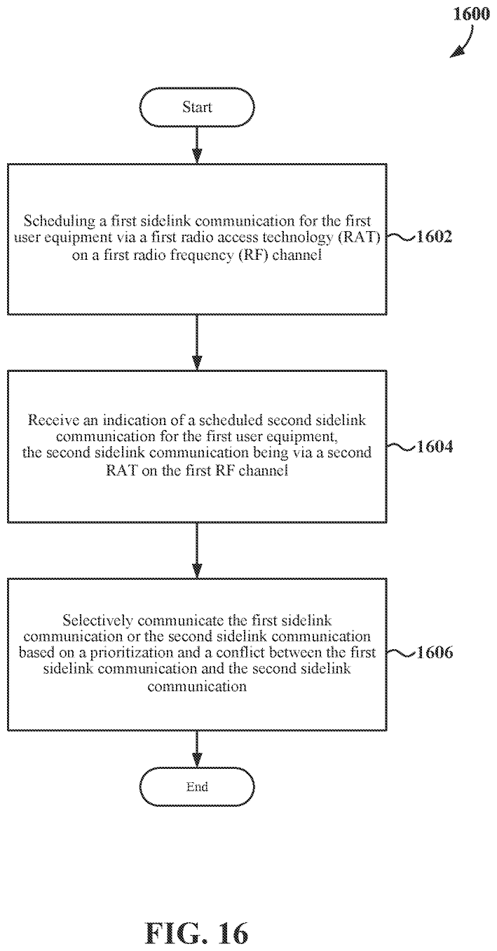

FIG. 16 is a flow chart of a method 1600 for wireless communication according to some aspects. As described below, some or all illustrated features may be omitted in a particular implementation within the scope of the present disclosure, and some illustrated features may not be required for implementation of all examples. In some examples, the method 1600 may be performed by the user equipment 1000 (e.g., performed by the processing system 1014), as described above and illustrated in FIG. 10, by a processor or processing system, or by any suitable means for carrying out the described functions.

At block 1602, a user equipment may schedule a first sidelink communication for the user equipment via a first radio access technology (RAT) on a first radio frequency (RF) channel. For example, the schedule processing circuitry 1043 together with the communication and processing circuitry 1041 and the transceiver 1010, shown and described above in connection with FIG. 10, may provide a means to schedule a first sidelink communication for the user equipment via a first radio access technology (RAT) on a first radio frequency (RF) channel.

At block 1604, a user equipment may receive an indication of a scheduled second sidelink communication for the user equipment, the second sidelink communication being via a second RAT on the first RF channel. For example, the schedule processing circuitry 1043 together with the communication and processing circuitry 1041 and the transceiver 1010, shown and described above in connection with FIG. 10, may provide a means to receive an indication of a scheduled second sidelink communication for the user equipment, the second sidelink communication being via a second RAT on the first RF channel.

At block 1606, a user equipment may selectively communicate the first sidelink communication or the second sidelink communication based on a prioritization and a conflict between the first sidelink transmission and the second sidelink transmission. For example, the resource sharing processing circuitry 1042 together with the communication and processing circuitry 1041 and the transceiver 1010, shown and described above in connection with FIG. 10, may provide a means to selectively communicate the first sidelink communication or the second sidelink communication based on a prioritization and a conflict between the first sidelink transmission and the second sidelink transmission.

In some examples, the first RAT may include a third generation partnership project (3GPP) new radio (NR) technology. In some examples, the second RAT may include a 3GPP long term evolution (LTE) technology.

In some examples, the prioritization is associated with transmissions.

In some examples, the user equipment may cancel the first sidelink communication based on the first sidelink communication being a receive operation and the second sidelink communication being a transmit operation. In some examples, the user equipment may cancel the second sidelink communication based on the second sidelink communication being a receive operation and the first sidelink communication being a transmit operation.

In some examples, the user equipment may transmit a negative acknowledgement for the second sidelink communication based on the cancellation of the second sidelink communication and a reservation of resources for the second sidelink communication, the negative acknowledgement being transmitted on a feedback resource indicated by sidelink control information that reserved the second sidelink communication.

In some examples, the user equipment may cancel the first sidelink communication based on a configuration that specifies that transmissions on the first RAT are to be dropped when there is a conflict between transmissions on the first RAT and the second RAT. In some examples, the user equipment may cancel the second sidelink communication based on a configuration that specifies that transmissions on the second RAT are to be dropped when there is a conflict between transmissions on the first RAT and the second RAT.

In some examples, the user equipment may cancel the first sidelink communication. In some examples, the user equipment may selectively exclude at least one resource from a first sidelink transmission resource set associated with the first RAT based on the cancellation of the first sidelink communication.

In some examples, the at least one resource may include at least one slot that is associated with a periodic resource allocation. In some examples, the at least one resource may include at least one slot that follows a first slot associated with the first sidelink communication by a quantity of slots specified by at least one configured parameter.

In some examples, the user equipment may cancel the second sidelink communication. In some examples, the user equipment may retransmit the second sidelink communication.

In some examples, the retransmission of the second sidelink communication is independent of a feedback status associated with the second sidelink communication. In some examples, the retransmission of the second sidelink communication is based on whether a quantity of retransmissions for the second sidelink communication is greater than or equal to a threshold quantity of retransmissions associated with the second sidelink communication. In some examples, the retransmission of the second sidelink communication is based on whether the quantity of retransmissions for the second sidelink communication is greater than or equal to a sum of the threshold quantity of retransmissions associated with the second sidelink communication and a quantity of dropped transmissions associated with the second sidelink communication.

In some examples, the user equipment may retransmit the second sidelink communication on a first set of resources that is different from a second set of resources scheduled for the second sidelink communication. In some examples, the user equipment may retransmit the second sidelink communication on the same set of resources that were scheduled for the second sidelink communication.

In some examples, the retransmission of the second sidelink communication may include at least a first retransmission of the second sidelink communication on a first set of resources that were scheduled for the second sidelink communication. In some examples, the retransmission of the second sidelink communication may include at least a second retransmission of the second sidelink communication on a second set of resources that is different from the first set of resources.

In some examples, the prioritization is a RAT prioritization.

In some examples, the user equipment may cancel the first sidelink communication based on a configuration that specifies that communications on the first RAT are to be dropped when there is a conflict between communications on the first RAT and the second RAT, and further based on the first sidelink communication and the second sidelink communication having the same priority.

In some examples, the user equipment may cancel the first sidelink communication based on a configuration that specifies that communications on the first RAT are to be dropped when there is a conflict between communications on the first RAT and the second RAT.

In some examples, the user equipment may cancel the first sidelink communication. In some examples, the user equipment may transmit an indication of at least one resource associated with the first sidelink communication. In some examples, the at least one resource associated with the first sidelink communication may include a resource scheduled for a future sidelink communication via the first RAT.

In some examples, the user equipment may include a third generation partnership project (3GPP) long term evolution (LTE) sidelink module and a 3GPP new radio (NR) sidelink module. In some examples, the LTE sidelink module may transmit the indication to the NR sidelink module. In some examples, the NR sidelink module may exclude the at least one resource from a sidelink transmission resource set for the second RAT.

Referring again to FIG. 10, in one configuration, the user equipment 1000 includes means for receiving an indication of a first sidelink transmission resource set, the first sidelink transmission resource set being associated with at least one second sidelink communication for the user equipment via a second radio access technology (RAT) on a first radio frequency (RF) channel, and means for communicating sidelink information for the user equipment on a second sidelink transmission resource set via a first RAT on the first RF channel, the second sidelink transmission resource set being based on selectively excluding at least one resource indicated by the first sidelink transmission resource set. In one configuration, the user equipment 1000 includes means for scheduling a first sidelink communication for the user equipment via a first radio access technology (RAT) on a first radio frequency (RF) channel, means for receiving an indication of a scheduled second sidelink communication for the user equipment, the second sidelink communication being via a second RAT on the first RF channel, and means for selectively communicating the first sidelink communication or the second sidelink communication based on a conflict between the first sidelink communication and the second sidelink communication and a prioritization associated with transmissions. In one configuration, the user equipment 1000 includes means for scheduling a first sidelink communication for the user equipment via a first radio access technology (RAT) on a first radio frequency (RF) channel, means for receiving an indication of a scheduled second sidelink communication for the user equipment, the second sidelink communication being via a second RAT on the first RF channel, and means for selectively communicating the first sidelink communication or the second sidelink communication based on a conflict between the first sidelink transmission and the second sidelink transmission and a RAT prioritization. In one configuration, the user equipment 1000 includes means for scheduling a first sidelink communication for the user equipment via a first radio access technology (RAT) on a first radio frequency (RF) channel, means for receiving an indication of a scheduled second sidelink communication for the user equipment, the second sidelink communication being via a second RAT on the first RF channel, and means for selectively communicating the first sidelink communication or the second sidelink communication based on a prioritization and a conflict between the first sidelink transmission and the second sidelink transmission. In one aspect, the aforementioned means may be the processor 1004 shown in FIG. 10 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1004 is merely provided as an example, and other means for carrying out the described functions may be included within various aspects of the present disclosure, including but not limited to the instructions stored in the computer-readable medium 1006, or any other suitable apparatus or means described in any one or more of FIGS. 1, 3, 5, 7, 8, 9, and 10 and utilizing, for example, the methods and/or algorithms described herein in relation to FIGS. 11-16. The methods shown in FIGS. 11-16 may include additional aspects, such as any single aspect or any combination of aspects described below and/or in connection with one or more other processes described elsewhere herein.

In some examples, a user equipment may include one or more memories storing processor-executable code, and one or more processors. The one or more processors may be configured to execute the processor-executable code to cause the user equipment to schedule a first sidelink communication for the user equipment via a first radio access technology (RAT) on a first radio frequency (RF) channel. The one or more processors may also be configured to execute the processor-executable code to cause the user equipment to receive an indication of a scheduled second sidelink communication for the user equipment, the second sidelink communication being via a second RAT on the first RF channel. The one or more processors may further be configured to execute the processor-executable code to cause the user equipment to selectively communicate the first sidelink communication or the second sidelink communication based on a conflict between the first sidelink communication and the second sidelink communication and a prioritization associated with transmissions.

In some examples, a method for wireless communication at a user equipment is disclosed. The method may include scheduling a first sidelink communication for the user equipment via a first radio access technology (RAT) on a first radio frequency (RF) channel. The method may also include receiving an indication of a scheduled second sidelink communication for the user equipment, the second sidelink communication being via a second RAT on the first RF channel. The method may further include selectively communicating the first sidelink communication or the second sidelink communication based on a conflict between the first sidelink communication and the second sidelink communication and a prioritization associated with transmissions.

In some examples, a user equipment may include means for scheduling a first sidelink communication for the user equipment via a first radio access technology (RAT) on a first radio frequency (RF) channel. The user equipment may also include means for receiving an indication of a scheduled second sidelink communication for the user equipment, the second sidelink communication being via a second RAT on the first RF channel. The user equipment may further include means for selectively communicating the first sidelink communication or the second sidelink communication based on a conflict between the first sidelink communication and the second sidelink communication and a prioritization associated with transmissions.

In some examples, a non-transitory computer-readable medium has stored therein instructions executable by one or more processors of a user equipment to schedule a first sidelink communication for the user equipment via a first radio access technology (RAT) on a first radio frequency (RF) channel. The computer-readable medium may also have stored therein instructions executable by one or more processors of the user equipment to receive an indication of a scheduled second sidelink communication for the user equipment, the second sidelink communication being via a second RAT on the first RF channel. The computer-readable medium may further have stored therein instructions executable by one or more processors of the user equipment to selectively communicate the first sidelink communication or the second sidelink communication based on a conflict between the first sidelink communication and the second sidelink communication and a prioritization associated with transmissions.

In some examples, a user equipment may include one or more memories storing processor-executable code, and one or more processors. The one or more processors may be configured to execute the processor-executable code to cause the user equipment to schedule a first sidelink communication for the user equipment via a first radio access technology (RAT) on a first radio frequency (RF) channel. The one or more processors may also be configured to execute the processor-executable code to cause the user equipment to receive an indication of a scheduled second sidelink communication for the user equipment, the second sidelink communication being via a second RAT on the first RF channel. The one or more processors may further be configured to execute the processor-executable code to cause the user equipment to selectively communicate the first sidelink communication or the second sidelink communication based on a conflict between the first sidelink transmission and the second sidelink transmission and a RAT prioritization.

In some examples, a method for wireless communication at a user equipment is disclosed. The method may include scheduling a first sidelink communication for the user equipment via a first radio access technology (RAT) on a first radio frequency (RF) channel. The method may also include receiving an indication of a scheduled second sidelink communication for the user equipment, the second sidelink communication being via a second RAT on the first RF channel. The method may further include selectively communicating the first sidelink communication or the second sidelink communication based on a conflict between the first sidelink transmission and the second sidelink transmission and a RAT prioritization.

In some examples, a user equipment may include means for scheduling a first sidelink communication for the user equipment via a first radio access technology (RAT) on a first radio frequency (RF) channel. The user equipment may also include means for receiving an indication of a scheduled second sidelink communication for the user equipment, the second sidelink communication being via a second RAT on the first RF channel. The user equipment may further include means for selectively communicating the first sidelink communication or the second sidelink communication based on a conflict between the first sidelink transmission and the second sidelink transmission and a RAT prioritization.

In some examples, a non-transitory computer-readable medium has stored therein instructions executable by one or more processors of a user equipment to schedule a first sidelink communication for the user equipment via a first radio access technology (RAT) on a first radio frequency (RF) channel. The computer-readable medium may also have stored therein instructions executable by one or more processors of the user equipment to receive an indication of a scheduled second sidelink communication for the user equipment, the second sidelink communication being via a second RAT on the first RF channel. The computer-readable medium may further have stored therein instructions executable by one or more processors of the user equipment to selectively communicate the first sidelink communication or the second sidelink communication based on a conflict between the first sidelink transmission and the second sidelink transmission and a RAT prioritization.

The following provides an overview of several aspects of the present disclosure.

Aspect 1: A method for wireless communication at a user equipment, the method comprising: receiving an indication of a first sidelink transmission resource set, the first sidelink transmission resource set being associated with at least one first sidelink communication for the user equipment via a first radio access technology (RAT) on a first radio frequency (RF) channel; and communicating sidelink information for the user equipment on a second sidelink transmission resource set via a second RAT on the first RF channel, the second sidelink transmission resource set being based on selectively excluding or including at least one resource indicated by the first sidelink transmission resource set.

Aspect 2: The method of aspect 1, wherein: the first RAT comprises a third generation partnership project (3GPP) new radio (NR) technology; and the second RAT comprises a 3GPP long term evolution (LTE) technology.

Aspect 3: The method of aspect 2, wherein: the user equipment comprises an LTE sidelink module and an NR sidelink module; and the receiving the indication of the first sidelink transmission resource set comprises receiving, at the LTE sidelink module, an NR transmission resource set from the NR sidelink module.

Aspect 4: The method of any of aspects 1 through 3, further comprising: receiving first resource utilization information, the first resource utilization information being associated with at least one second sidelink communication via the second RAT on the first RF channel, wherein the second sidelink transmission resource set is based on the first resource utilization information.

Aspect 5: The method of any of aspects 1 through 4, wherein the selectively excluding or including the at least one resource indicated by the first sidelink transmission resource set comprises: excluding all resources indicated by the first sidelink transmission resource set from the second sidelink transmission resource set.

Aspect 6: The method of any of aspects 1 through 4, wherein the selectively excluding or including the at least one resource indicated by the first sidelink transmission resource set comprises: excluding, from the second sidelink transmission resource set, slots with resources for feedback transmissions indicated by the first sidelink transmission resource set.

Aspect 7: The method of any of aspects 1 through 6, wherein the selectively excluding or including the at least one resource indicated by the first sidelink transmission resource set is based on a relative priority between transmissions via the first RAT and transmissions via the second RAT.

Aspect 8: The method of any of aspects 1 through 7, wherein the selectively excluding or including the at least one resource indicated by the first sidelink transmission resource set comprises: excluding, from the second sidelink transmission resource set, the at least one resource indicated by the first sidelink transmission resource set based on the first RAT being associated with a first priority that is higher than a second priority associated with the second RAT.

Aspect 9: The method of any of aspects 1 through 7, wherein the selectively excluding or including the at least one resource indicated by the first sidelink transmission resource set comprises: including, in the second sidelink transmission resource set, the at least one resource indicated by the first sidelink transmission resource set based on the first RAT being associated with a first priority that is lower than a second priority associated with the second RAT.

Aspect 10: The method of any of aspects 1 through 9, wherein: the user equipment comprises a third generation partnership project (3GPP) long term evolution (LTE) sidelink module and a 3GPP new radio (NR) sidelink module; the LTE sidelink module forwards the indication of the first sidelink transmission resource set to a medium access control layer; and the medium access control layer updates the second sidelink transmission resource set based on the first sidelink transmission resource set.

Aspect 11: The method of any of aspects 1 through 10, wherein the user equipment comprises: a third generation partnership project (3GPP) long term evolution (LTE) sidelink module; a 3GPP new radio (NR) sidelink module; and a bi-directional interface between the LTE sidelink module and the NR sidelink module.

Aspect 12: A method for wireless communication at a user equipment, the method comprising: scheduling a first sidelink communication for the user equipment via a first radio access technology (RAT) on a first radio frequency (RF) channel; receiving an indication of a scheduled second sidelink communication for the user equipment, the second sidelink communication being via a second RAT on the first RF channel; and selectively communicating the first sidelink communication or the second sidelink communication based on a conflict between the first sidelink communication and the second sidelink communication and a prioritization associated with transmissions.

Aspect 13: The method of aspect 12, wherein: the first RAT comprises a third generation partnership project (3GPP) long term evolution (LTE) technology; and the second RAT comprises a 3GPP new radio (NR) technology.

Aspect 14: The method of any of aspects 12 through 13, wherein the selectively communicating the first sidelink communication or the second sidelink communication based on the conflict between the first sidelink communication and the second sidelink communication and the prioritization associated with transmissions comprises: canceling the first sidelink communication based on the first sidelink communication being a receive operation and the second sidelink communication being a transmit operation.

Aspect 15: The method of any of aspects 12 through 13, wherein the selectively communicating the first sidelink communication or the second sidelink communication based on the conflict between the first sidelink communication and the second sidelink communication and the prioritization associated with transmissions comprises: canceling the second sidelink communication based on the second sidelink communication being a receive operation and the first sidelink communication being a transmit operation.

Aspect 16: The method of aspect 15, further comprising: transmitting a negative acknowledgement for the second sidelink communication based on a reservation of resources for the second sidelink communication, the negative acknowledgement being transmitted on a feedback resource indicated by sidelink control information that reserved the second sidelink communication.

Aspect 17: The method of any of aspects 12 through 13, wherein the selectively communicating the first sidelink communication or the second sidelink communication based on the conflict between the first sidelink communication and the second sidelink communication and the prioritization associated with transmissions comprises: canceling the first sidelink communication based on a configuration that specifies that transmissions on the first RAT are to be dropped when there is a conflict between transmissions on the first RAT and the second RAT.

Aspect 18: The method of any of aspects 12 through 13, wherein the selectively communicating the first sidelink communication or the second sidelink communication based on the conflict between the first sidelink transmission and the second sidelink transmission and the prioritization associated with transmissions comprises: canceling the second sidelink communication based on a configuration that specifies that transmissions on the second RAT are to be dropped when there is a conflict between transmissions on the first RAT and the second RAT.

Aspect 19: The method of any of aspects 12 through 13, wherein: the selectively communicating the first sidelink communication or the second sidelink communication based on the conflict between the first sidelink communication and the second sidelink communication and the prioritization associated with transmissions comprises canceling the first sidelink communication; and the method further comprises selectively excluding at least one resource from a first sidelink transmission resource set associated with the first RAT based on the canceling the first sidelink communication.

Aspect 20: The method of aspect 19, wherein the at least one resource comprises at least one slot that is associated with a periodic resource allocation.

Aspect 21: The method of aspect 19, wherein the at least one resource comprises at least one slot that follows a first slot associated with the first sidelink communication by a quantity of slots specified by at least one configured parameter.

Aspect 22: The method of any of aspects 12 through 13, wherein: the selectively communicating the first sidelink communication or the second sidelink communication based on the conflict between the first sidelink communication and the second sidelink communication and the prioritization associated with transmissions comprises canceling the second sidelink communication; and the method further comprises retransmitting the second sidelink communication.

Aspect 23: The method of aspect 22, wherein the retransmitting the second sidelink communication is independent of a feedback status associated with the second sidelink communication.

Aspect 24: The method of any of aspects 22 through 23, wherein the retransmitting the second sidelink communication is based on whether a quantity of retransmissions for the second sidelink communication is greater than or equal to a threshold quantity of retransmissions associated with the second sidelink communication.

Aspect 25: The method of any of aspects 22 through 23, wherein the retransmitting the second sidelink communication is based on whether a quantity of retransmissions for the second sidelink communication is greater than or equal to a sum of a threshold quantity of retransmissions associated with the second sidelink communication and a quantity of dropped transmissions associated with the second sidelink communication.

Aspect 26: The method of any of aspects 22 through 25, wherein the retransmitting the second sidelink communication comprises: retransmitting the second sidelink communication on a first set of resources that is different from a second set of resources scheduled for the second sidelink communication.

Aspect 27: The method of any of aspects 22 through 25, wherein the retransmitting the second sidelink communication comprises: retransmitting the second sidelink communication on the same set of resources that were scheduled for the second sidelink communication.

Aspect 28: The method of any of aspects 22 through 25, wherein the retransmitting the second sidelink communication comprises: transmitting at least a first retransmission of the second sidelink communication on a first set of resources that were scheduled for the second sidelink communication; and transmitting at least a second retransmission of the second sidelink communication on a second set of resources that is different from the first set of resources.

Aspect 29: A method for wireless communication at a user equipment, the method comprising: scheduling a first sidelink communication for the user equipment via a first radio access technology (RAT) on a first radio frequency (RF) channel; receiving an indication of a scheduled second sidelink communication for the user equipment, the second sidelink communication being via a second RAT on the first RF channel; and selectively communicating the first sidelink communication or the second sidelink communication based on a conflict between the first sidelink transmission and the second sidelink transmission and a RAT prioritization.

Aspect 30: The method of aspect 29, wherein: the first RAT comprises a third generation partnership project (3GPP) long term evolution (LTE) technology; and the second RAT comprises a 3GPP new radio (NR) technology.

Aspect 31: The method of any of aspects 29 through 30, wherein the selectively communicating the first sidelink communication or the second sidelink communication based on the conflict between the first sidelink transmission and the second sidelink transmission and the RAT prioritization comprises: canceling the first sidelink communication based on a configuration that specifies that communications on the first RAT are to be dropped when there is a conflict between communications on the first RAT and the second RAT, and further based on the first sidelink communication and the second sidelink communication having the same priority.

Aspect 32: The method of any of aspects 29 through 30, wherein the selectively communicating the first sidelink communication or the second sidelink communication based on the conflict between the first sidelink transmission and the second sidelink transmission and the RAT prioritization comprises: canceling the first sidelink communication based on a configuration that specifies that communications on the first RAT are to be dropped when there is a conflict between communications on the first RAT and the second RAT.

Aspect 33: The method of any of aspects 29 through 32, wherein: the selectively communicating the first sidelink communication or the second sidelink communication based on the conflict between the first sidelink transmission and the second sidelink transmission and the RAT prioritization comprises canceling the first sidelink communication; and the method further comprises selectively excluding at least one resource from a first sidelink transmission resource set associated with the first RAT based on the canceling the first sidelink communication.

Aspect 34: The method of aspect 33, wherein the at least one resource comprises at least one slot that is associated with a periodic resource allocation.

Aspect 35: The method of aspect 33, wherein the at least one resource comprises at least one slot that follows a first slot associated with the first sidelink communication by a quantity of slots specified by at least one configured parameter.

Aspect 36: The method of any of aspects 29 through 30, wherein: the selectively communicating the first sidelink communication or the second sidelink communication based on the conflict between the first sidelink transmission and the second sidelink transmission and the RAT prioritization comprises canceling the first sidelink communication; and the method further comprises transmitting an indication of at least one resource associated with the first sidelink communication.

Aspect 37: The method of aspect 36, wherein the at least one resource associated with the first sidelink communication comprises a resource scheduled for a future sidelink communication via the first RAT.

Aspect 38: The method of aspect 36, wherein: the user equipment comprises a third generation partnership project (3GPP) long term evolution (LTE) sidelink module and a 3GPP new radio (NR) sidelink module; the transmitting the indication of the at least one resource comprises the LTE sidelink module transmitting the indication to the NR sidelink module; and the method further comprises the NR sidelink module excluding the at least one resource from a sidelink transmission resource set for the second RAT.

Aspect 39: The method of any of aspects 29 through 30, wherein: the selectively communicating the first sidelink communication or the second sidelink communication based on the conflict between the first sidelink transmission and the second sidelink transmission and the RAT prioritization comprises canceling the second sidelink communication; and the method further comprises retransmitting the second sidelink communication.

Aspect 40: The method of aspect 39, wherein the retransmitting the second sidelink communication is independent of a feedback status associated with the second sidelink communication.

Aspect 41: The method of any of aspects 39 through 40, wherein the retransmitting the second sidelink communication is based on whether a quantity of retransmissions for the second sidelink communication is greater than or equal to a threshold quantity of retransmissions associated with the second sidelink communication.

Aspect 42: The method of any of aspects 39 through 40, wherein the retransmitting the second sidelink communication is based on whether a quantity of retransmissions for the second sidelink communication is greater than or equal to a sum of a threshold quantity of retransmissions associated with the second sidelink communication and a quantity of dropped transmissions associated with the second sidelink communication.

Aspect 43: The method of any of aspects 39 through 40, wherein the retransmitting the second sidelink communication comprises: retransmitting the second sidelink communication on a first set of resources that is different from a second set of resources scheduled for the second sidelink communication.

Aspect 44: The method of any of aspects 39 through 40, wherein the retransmitting the second sidelink communication comprises: retransmitting the second sidelink communication on the same set of resources that were scheduled for the second sidelink communication.

Aspect 45: The method of any of aspects 39 through 40, wherein the retransmitting the second sidelink communication comprises: transmitting at least a first retransmission of the second sidelink communication on a first set of resources that were scheduled for the second sidelink communication; and transmitting at least a second retransmission of the second sidelink communication on a second set of resources that is different from the first set of resources.

Aspect 46: A method for wireless communication at a user equipment, the method comprising: scheduling a first sidelink communication for the user equipment via a first radio access technology (RAT) on a first radio frequency (RF) channel; receiving an indication of a scheduled second sidelink communication for the user equipment, the second sidelink communication being via a second RAT on the first RF channel; and selectively communicating the first sidelink communication or the second sidelink communication based on a prioritization and a conflict between the first sidelink communication and the second sidelink communication.

Aspect 47: The method of aspect 46, wherein the prioritization is associated with transmissions.

Aspect 48: The method of any of aspects 46 through 47, further comprising: canceling the first sidelink communication based on the first sidelink communication being a receive operation and the second sidelink communication being a transmit operation; or canceling the second sidelink communication based on the second sidelink communication being the receive operation and the first sidelink communication being the transmit operation.

Aspect 49: The method of aspect 48, further comprising: transmitting a negative acknowledgement for the second sidelink communication based on the cancellation of the second sidelink communication and a reservation of resources for the second sidelink communication, the negative acknowledgement being transmitted on a feedback resource indicated by sidelink control information that reserved the second sidelink communication.

Aspect 50: The method of any of aspects 46 through 47, further comprising: canceling the first sidelink communication based on a first configuration that specifies that transmissions on the first RAT are to be dropped when there is a conflict between scheduled transmissions on the first RAT and the second RAT; or canceling the second sidelink communication based on a second configuration that specifies that transmissions on the second RAT are to be dropped when there is a conflict between the scheduled transmissions on the first RAT and the second RAT.

Aspect 51: The method of any of aspects 46 through 47, further comprising: canceling the first sidelink communication; and selectively excluding at least one resource from a first sidelink transmission resource set associated with the first RAT based on the cancellation of the first sidelink communication.

Aspect 52: The method of aspect 51, wherein the at least one resource comprises at least one slot that: is associated with a periodic resource allocation; or follows a first slot associated with the first sidelink communication by a quantity of slots specified by at least one configured parameter.

Aspect 53: The method of any of aspects 46 through 47, further comprising: canceling the second sidelink communication; and retransmitting the second sidelink communication.

Aspect 54: The method of aspect 53, wherein the retransmission of the second sidelink communication is: independent of a feedback status associated with the second sidelink communication; based on whether a quantity of retransmissions for the second sidelink communication is greater than or equal to a threshold quantity of retransmissions associated with the second sidelink communication; or based on whether the quantity of retransmissions for the second sidelink communication is greater than or equal to a sum of the threshold quantity of retransmissions associated with the second sidelink communication and a quantity of dropped transmissions associated with the second sidelink communication.

Aspect 55: The method of any of aspects 53 through 54, further comprising retransmitting the second sidelink communication: on a first set of resources that is different from a second set of resources scheduled for the second sidelink communication; or on the same set of resources that were scheduled for the second sidelink communication.

Aspect 56: The method of any of aspects 53 through 54, wherein the retransmission of the second sidelink communication comprises: at least a first retransmission of the second sidelink communication on a first set of resources that were scheduled for the second sidelink communication; and at least a second retransmission of the second sidelink communication on a second set of resources that is different from the first set of resources.

Aspect 57: The method of any of aspects 46 through 56, wherein the prioritization comprises a RAT prioritization.

Aspect 58: The method of aspect 57, further comprising: canceling the first sidelink communication based on a configuration that specifies that communications on the first RAT are to be dropped when there is a conflict between communications on the first RAT and the second RAT, and further based on the first sidelink communication and the second sidelink communication having the same priority.

Aspect 59: The method of aspect 57, further comprising: canceling the first sidelink communication based on a configuration that specifies that communications on the first RAT are to be dropped when there is a conflict between communications on the first RAT and the second RAT.

Aspect 60: The method of aspect 57, further comprising: canceling the first sidelink communication; and transmitting an indication of at least one resource associated with the first sidelink communication.

Aspect 61: The method of aspect 60, wherein the at least one resource associated with the first sidelink communication comprises a resource scheduled for a future sidelink communication via the first RAT.

Aspect 62: The method of any of aspects 60 through 61, wherein: the user equipment further comprises a third generation partnership project (3GPP) long term evolution (LTE) sidelink module and a 3GPP new radio (NR) sidelink module; the LTE sidelink module transmits the indication to the NR sidelink module; and the NR sidelink module excludes the at least one resource from a sidelink transmission resource set for the second RAT.

Aspect 63: A user equipment comprising: a transceiver configured to communicate with a radio access network, one or more memories, and one or more processors coupled to the transceiver and the one or more memories, wherein the one or more processors are configured to perform any one or more of aspects 1 through 11.

Aspect 64: An apparatus configured for wireless communication comprising at least one means for performing any one or more of aspects 1 through 11.

Aspect 65: A non-transitory computer-readable medium storing computer-executable code, comprising code for causing an apparatus to perform any one or more of aspects 1 through 11.

Aspect 66: A user equipment comprising: a transceiver configured to communicate with a radio access network, one or more memories, and one or more processors coupled to the transceiver and the one or more memories, wherein the one or more processors are configured to perform any one or more of aspects 12 through 28.

Aspect 67: An apparatus configured for wireless communication comprising at least one means for performing any one or more of aspects 12 through 28.

Aspect 68: A non-transitory computer-readable medium storing computer-executable code, comprising code for causing an apparatus to perform any one or more of aspects 12 through 28.

Aspect 69: A user equipment comprising: a transceiver configured to communicate with a radio access network, one or more memories, and one or more processors coupled to the transceiver and the one or more memories, wherein the one or more processors are configured to perform any one or more of aspects 29 through 45.

Aspect 70: An apparatus configured for wireless communication comprising at least one means for performing any one or more of aspects 29 through 45.

Aspect 71: A non-transitory computer-readable medium storing computer-executable code, comprising code for causing an apparatus to perform any one or more of aspects 29 through 45.

Aspect 72: A user equipment comprising: a transceiver configured to communicate with a radio access network, one or more memories, and one or more processors coupled to the transceiver and the one or more memories, wherein the one or more processors are configured to perform any one or more of aspects 46 through 62.

Aspect 73: An apparatus configured for wireless communication comprising at least one means for performing any one or more of aspects 46 through 62.

Aspect 74: A non-transitory computer-readable medium storing computer-executable code, comprising code for causing an apparatus to perform any one or more of aspects 46 through 62.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing Institute of Electrical and Electronics Engineers (IEEE) 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-16 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 3, 5, 7, 8, 9, and 10 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A user equipment, comprising:
one or more memories storing processor-executable code; and
one or more processors configured to execute the processor-executable code to cause the user equipment to:
receive an indication of a first sidelink transmission resource set, the first sidelink transmission resource set being associated with at least one first sidelink communication for the user equipment via a first radio access technology (RAT) on a first radio frequency (RF) channel; and
communicate sidelink information for the user equipment on a second sidelink transmission resource set via a second RAT on the first RF channel, the second sidelink transmission resource set being based on a selective exclusion or inclusion of at least one resource indicated by the first sidelink transmission resource set.

2. The user equipment of claim 1, wherein:
the first RAT comprises a third generation partnership project (3GPP) new radio (NR) technology; and
the second RAT comprises a 3GPP long term evolution (LTE) technology.

3. The user equipment of claim 2, wherein:
the user equipment further comprises an LTE sidelink module and an NR sidelink module; and
the receipt of the indication of the first sidelink transmission resource set comprises receipt, at the LTE sidelink module, of an NR transmission resource set from the NR sidelink module.

4. The user equipment of claim 1, wherein:
the one or more processors are further configured to execute the processor-executable code to cause the user equipment to receive first resource utilization information, the first resource utilization information being associated with at least one second sidelink communication via the second RAT on the first RF channel; and
the second sidelink transmission resource set is based on the first resource utilization information.

5. The user equipment of claim 1, wherein the one or more processors are further configured to execute the processor-executable code to cause the user equipment to:
exclude all resources indicated by the first sidelink transmission resource set from the second sidelink transmission resource set.

6. The user equipment of claim 1, wherein the one or more processors are further configured to execute the processor-executable code to cause the user equipment to:
exclude, from the second sidelink transmission resource set, slots with resources for feedback transmissions indicated by the first sidelink transmission resource set.

7. The user equipment of claim 1, wherein the one or more processors are further configured to execute the processor-executable code to cause the user equipment to:
selectively exclude the at least one resource indicated by the first sidelink transmission resource set based on a relative priority between transmissions via the first RAT and transmissions via the second RAT.

8. The user equipment of claim 1, wherein the one or more processors are further configured to execute the processor-executable code to cause the user equipment to:
exclude, from the second sidelink transmission resource set, the at least one resource indicated by the first sidelink transmission resource set based on the first RAT being associated with a first priority that is higher than a second priority associated with the second RAT.

9. The user equipment of claim 1, wherein the one or more processors are further configured to execute the processor-executable code to cause the user equipment to:
include, in the second sidelink transmission resource set, the at least one resource indicated by the first sidelink transmission resource set based on the first RAT being associated with a first priority that is lower than a second priority associated with the second RAT.

10. The user equipment of claim 1, wherein:
the user equipment further comprises a third generation partnership project (3GPP) long term evolution (LTE) sidelink module and a 3GPP new radio (NR) sidelink module;
the LTE sidelink module is configured to forward the indication of the first sidelink transmission resource set to a medium access control layer; and
the medium access control layer is configured to update the second sidelink transmission resource set based on the first sidelink transmission resource set.

11. The user equipment of claim 1, wherein the user equipment further comprises:
a third generation partnership project (3GPP) long term evolution (LTE) sidelink module;
a 3GPP new radio (NR) sidelink module; and
a bi-directional interface between the LTE sidelink module and the NR sidelink module.

12. A method for wireless communication at a user equipment, the method comprising:
receiving an indication of a first sidelink transmission resource set, the first sidelink transmission resource set being associated with at least one first sidelink communication for the user equipment via a first radio access technology (RAT) on a first radio frequency (RF) channel; and
communicating sidelink information for the user equipment on a second sidelink transmission resource set via a second RAT on the first RF channel, the second sidelink transmission resource set being based on selectively excluding or including at least one resource indicated by the first sidelink transmission resource set.

13. A user equipment, comprising:
one or more memories storing processor-executable code; and
one or more processors configured to execute the processor-executable code to cause the user equipment to:
schedule a first sidelink communication for the user equipment via a first radio access technology (RAT) on a first radio frequency (RF) channel;
receive an indication of a scheduled second sidelink communication for the user equipment, the second sidelink communication being via a second RAT on the first RF channel; and
selectively communicate the first sidelink communication or the second sidelink communication based on a prioritization and a conflict between the first sidelink communication and the second sidelink communication.

14. The user equipment of claim 13, wherein the prioritization is associated with transmissions.

15. The user equipment of claim 14, wherein the one or more processors are further configured to execute the processor-executable code to cause the user equipment to:
cancel the first sidelink communication based on the first sidelink communication being a receive operation and the second sidelink communication being a transmit operation; or
cancel the second sidelink communication based on the second sidelink communication being the receive operation and the first sidelink communication being the transmit operation.

16. The user equipment of claim 15, wherein the one or more processors are further configured to execute the processor-executable code to cause the user equipment to:
transmit a negative acknowledgement for the second sidelink communication based on the cancellation of the second sidelink communication and a reservation of resources for the second sidelink communication, the negative acknowledgement being transmitted on a feedback resource indicated by sidelink control information that reserved the second sidelink communication.

17. The user equipment of claim 14, wherein the one or more processors are further configured to execute the processor-executable code to cause the user equipment to:
cancel the first sidelink communication based on a first configuration that specifies that transmissions on the first RAT are to be dropped when there is a conflict between scheduled transmissions on the first RAT and the second RAT; or
cancel the second sidelink communication based on a second configuration that specifies that transmissions on the second RAT are to be dropped when there is a conflict between the scheduled transmissions on the first RAT and the second RAT.

18. The user equipment of claim 13, wherein the one or more processors are further configured to execute the processor-executable code to cause the user equipment to:
cancel the first sidelink communication; and
selectively exclude at least one resource from a first sidelink transmission resource set associated with the first RAT based on the cancellation of the first sidelink communication.

19. The user equipment of claim 18, wherein the at least one resource comprises at least one slot that:
is associated with a periodic resource allocation; or
follows a first slot associated with the first sidelink communication by a quantity of slots specified by at least one configured parameter.

20. The user equipment of claim 13, wherein the one or more processors are further configured to execute the processor-executable code to cause the user equipment to:
cancel the second sidelink communication; and
retransmit the second sidelink communication.

21. The user equipment of claim 20, wherein the retransmission of the second sidelink communication is:
independent of a feedback status associated with the second sidelink communication;
based on whether a quantity of retransmissions for the second sidelink communication is greater than or equal to a threshold quantity of retransmissions associated with the second sidelink communication; or
based on whether the quantity of retransmissions for the second sidelink communication is greater than or equal to a sum of the threshold quantity of retransmissions associated with the second sidelink communication and a quantity of dropped transmissions associated with the second sidelink communication.

22. The user equipment of claim 20, wherein the one or more processors are further configured to execute the processor-executable code to cause the user equipment to retransmit the second sidelink communication:
on a first set of resources that is different from a second set of resources scheduled for the second sidelink communication; or
on the same set of resources that were scheduled for the second sidelink communication.

23. The user equipment of claim 20, wherein the retransmission of the second sidelink communication comprises:
at least a first retransmission of the second sidelink communication on a first set of resources that were scheduled for the second sidelink communication; and
at least a second retransmission of the second sidelink communication on a second set of resources that is different from the first set of resources.

24. The user equipment of claim 13, wherein the prioritization comprises a RAT prioritization.

25. The user equipment of claim 24, wherein the one or more processors are further configured to execute the processor-executable code to cause the user equipment to:
cancel the first sidelink communication based on a configuration that specifies that communications on the first RAT are to be dropped when there is a conflict between communications on the first RAT and the second RAT, and further based on the first sidelink communication and the second sidelink communication having the same priority.

26. The user equipment of claim 24, wherein the one or more processors are further configured to execute the processor-executable code to cause the user equipment to:
cancel the first sidelink communication based on a configuration that specifies that communications on the first RAT are to be dropped when there is a conflict between communications on the first RAT and the second RAT.

27. The user equipment of claim 24, wherein the one or more processors are further configured to execute the processor-executable code to cause the user equipment to:
cancel the first sidelink communication; and
transmit an indication of at least one resource associated with the first sidelink communication.

28. The user equipment of claim 27, wherein the at least one resource associated with the first sidelink communication comprises a resource scheduled for a future sidelink communication via the first RAT.

29. The user equipment of claim 27, wherein:
the user equipment further comprises a third generation partnership project (3GPP) long term evolution (LTE) sidelink module and a 3GPP new radio (NR) sidelink module;
the one or more processors are further configured to execute the processor-executable code to cause the LTE sidelink module to transmit the indication to the NR sidelink module; and
the one or more processors are further configured to execute the processor-executable code to cause the NR sidelink module to exclude the at least one resource from a sidelink transmission resource set for the second RAT.

30. A method for wireless communication at a user equipment, the method comprising:
scheduling a first sidelink communication for the user equipment via a first radio access technology (RAT) on a first radio frequency (RF) channel;
receiving an indication of a scheduled second sidelink communication for the user equipment, the second sidelink communication being via a second RAT on the first RF channel; and
selectively communicating the first sidelink communication or the second sidelink communication based on a prioritization and a conflict between the first sidelink communication and the second sidelink communication.
